(19) United States
(12) Patent Application Publication
(10) Pub. No.: US 2011/0085429 A1
(43) Pub. Date: Apr. 14, 2011

(54) RECORDING AND REPRODUCTION DEVICE

(75) Inventor: Wataru TACHIBANA, Osaka (JP)

(73) Assignee: PANASONIC CORPORATION, Osaka (JP)

(21) Appl. No.: 12/973,504

(22) Filed: Dec. 20, 2010

Related U.S. Application Data
(63) Continuation of application No. PCT/JP2009/002942, filed on Jun. 26, 2009.

(30) Foreign Application Priority Data
Jul. 1, 2008 (JP) 2008-172391

(51) Int. Cl. G11B 20/10

(52) U.S. Cl. 369/47.28; G9B/20.009

(57) ABSTRACT

A recording unit records data read from a buffer for storing therein data reproduced by a CD drive apparatus capable of adjusting a data reproduction volume which is a volume of data to be reproduced per unit time. A decision unit generates a signal which adjusts the data reproduction volume based on a buffering quantity in the buffer or a volume of dataflow in the recording unit, and outputs the generated signal to the CD drive apparatus.

### FIELD OF THE INVENTION

The present invention relates to an audio recording and reproduction apparatus applied to an apparatus equipped with a compact disc (CD) ripping mechanism.

### BACKGROUND OF THE INVENTION

Since around mid 1990s, an increasingly large population of audio listeners extracts audio data from CDs and records the extracted audio data in their PCs (personal computers) or digital audio players to enjoy audio contents. The digital audio players are far more advantageous than CD players in compactness and mobility, and it is convenient in view of storage stability of contents to extract data from CD which is rather space-consuming and store the extracted data in a hard disc drive (HDD) of the digital audio player or a flash memory. The market of digital audio players, which are thus user-friendly, is continuously growing. It is generally called ripping to extract audio data from CD and compress and store the extracted data. In this specification, an apparatus used to rip audio data is called a ripping apparatus. It is expected to increase a ripping speed in the ripping apparatus in order to upgrade the user-friendliness.

Describing the ripping, digital audio data supplied to the ripping apparatus from an audio data source (for example, CD drive apparatus) is temporarily stored in a data buffer provided to input CD signals and compressed by a data compressor, and the compressed data is temporarily retained in another data buffer provided to write data on a recording medium, and then recorded on the recording medium as contents data.

### Conventional Technology Document

### Patent Document

### Patent Document 1: Unexamined Japanese Patent Applications Laid-Open No. 2006-287738

### SUMMARY OF THE INVENTION

### Problem to be Solved by the Invention

An initial step to increase the ripping speed is to increase an input speed when the digital audio data is inputted to the ripping apparatus from the audio data source. To increase the input speed, however, involves the risk of system breakdown due to overflow of the buffers of the ripping apparatus where the data is temporarily stored. In the event of the overflowed buffers, it is technically very difficult to restart the ripping at any data position where the breakdown occurred, and the ripping after all must restart at the very beginning of, for example, music or CD. This has an adverse impact on the user-friendliness. Though a solution for eliminating the risk of the buffer overflow is to increase a buffer capacity, the solution is not a preferable option because it easily leads to cost increase.

To solve the conventional technical problem, the present invention provides a recording and reproduction apparatus capable of ripping audio data optimally and most speedily in dependence upon changing circumstances of a medium and a system.

### Means for Solving the Problem

A recording and reproduction apparatus according to an aspect of the present invention comprises:

a buffer for storing therein data reproduced by a CD drive apparatus capable of adjusting a data reproduction volume which is a volume of data to be reproduced per unit time;

a recording device for recording therein the data read from the buffer; and

a decision device for generating a signal which adjusts the data reproduction volume based on a buffering quantity in the buffer or a volume of data flow in the recording device to output the generated signal to the CD drive apparatus.

A recording and reproduction apparatus according to another aspect of the present invention comprises:

a buffer for storing therein data reproduced by a CD drive apparatus;

a recording device for recording therein the data read from the buffer;

a backup buffer management device having a backup buffer to be allocated to the buffer and managing the allocation of the backup buffer; and

a decision device for generating a signal which adjusts a buffering quantity of the backup buffer to be allocated based on a buffering quantity in the buffer or a volume of data flow in the recording device to output the generated signal to the CD drive apparatus.

According to the recording and reproduction apparatus provided by the present invention, variation of a speed at which the data is written in the medium and variation of a speed at which the buffering quantity increases and decreases are respectively measured and recorded to estimate the future condition of the apparatus based on the recorded values of variation, so that the rotational speed of the CD drive apparatus and the buffer allocation are suitably controlled. The recording and reproduction apparatus thus technically characterized can achieve a high ripping speed.

The recording and reproduction apparatus according to the present invention can rip the data at a most suitable speed then in dependence upon changing circumstances of the medium and system, thereby flexibly responding to the needs for improvement of the ripping speed. The apparatus can reproduce music and video images in a composite product without impacting on other blocks of higher priority.

### BRIEF DESCRIPTION OF THE DRAWINGS

FIG. 1 is a block diagram illustrating a structure of a CD ripping apparatus according to an exemplary embodiment 1 of the present invention.

FIG. 2 is a processing flow chart illustrating processing steps carried out by an optimum speed estimation and decision device according to the exemplary embodiment 1.

FIG. 3A is a diagram illustrating transitions of a buffering quantity and a CD rotational speed according to a conventional technology.

FIG. 3B is a diagram illustrating transition of a buffering quantity and a CD rotational speed according to the exemplary embodiment 1.

FIG. 4 is a block diagram illustrating a structure of a CD ripping apparatus according to an exemplary embodiment 2 of the present invention.

FIG. 5 is a processing flow chart illustrating processing steps carried out by an optimum speed estimation and decision device according to the exemplary embodiment 2.

FIG. 6 is a diagram illustrating transitions of decision points, a buffering quantity, and a CD rotational speed according to the exemplary embodiment 2.

FIG. 7 is a block diagram illustrating a structure of a CD ripping apparatus according to an exemplary embodiment 3 of the present invention.

FIG. 8 is a processing flow chart illustrating processing steps carried out by an optimum buffer allocation estimation and decision device according to the exemplary embodiment 3.

FIG. 9 is a diagram illustrating transitions of decision points, a buffering quantity, and a CD rotational speed according to the exemplary embodiment 3.

FIG. 10 is a block diagram illustrating a structure of a CD ripping apparatus according to an exemplary embodiment 4 of the present invention.

FIG. 11 is a processing flow chart illustrating processing steps carried out by an optimum buffer allocation estimation and decision device according to the exemplary embodiment 4.

FIG. 12 is a diagram illustrating transitions of decision points, a buffering quantity, and a CD rotational speed according to the exemplary embodiment 4.

FIG. 13 is a block diagram illustrating a structure of a CD ripping apparatus according to an exemplary embodiment 5 of the present invention.

FIG. 14 is a processing flow chart illustrating processing steps carried out by an optimum speed/buffer allocation estimation and decision device according to the exemplary embodiment 5.

FIG. 15 is a diagram illustrating transitions of decision points, a buffering quantity, and a CD rotational speed according to the exemplary embodiment 5.

FIG. 16 is a block diagram illustrating a structure of a CD ripping apparatus according to an exemplary embodiment 6 of the present invention.

FIG. 17 is a processing flow chart illustrating processing steps carried out by an optimum speed/buffer allocation estimation and decision device according to the exemplary embodiment 6.

FIG. 18 is a block diagram illustrating a structure of a conventional CD ripping apparatus.

### EXEMPLARY EMBODIMENTS FOR CARRYING OUT THE INVENTION

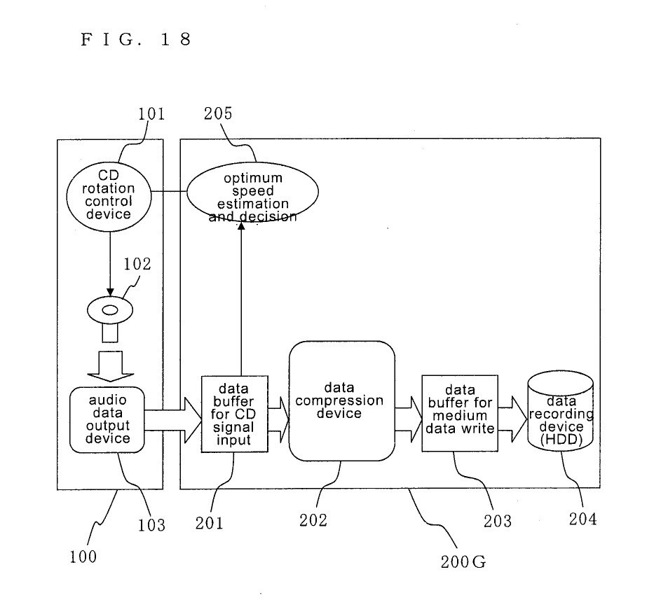

Before description of exemplary embodiments of the present invention start, extraction of CD data and read of data from a medium in a ripping apparatus are described in detail referring to FIG. 18. FIG. 18 is a block diagram illustrating a structure of a ripping system, wherein a data flow and signals are schematically illustrated. A CD drive apparatus 100 can adjust a data reproduction volume which is a volume of data to be reproduced per unit time. The CD drive apparatus 100 is provided with a CD rotation control device 101, a CD reproduction device 102, and an audio data output device 103. A ripping apparatus 200G is provided with a data buffer 201 for CD signal input, a data compression device 202, a data buffer for medium data write, a data recording device 204, and an optimum speed estimation and decision device 205.

Below are described processing steps for compressing digital audio data outputted from the CD drive apparatus 100 (for example, audio PCM (pulse-code modulation) data) and recording the compressed data in the data recording device 204 of the ripping apparatus 200G. The data buffer 201 for CD signal input is a buffer which stores therein the digital audio data outputted from the CD drive apparatus 100 to be compressed. The data compression device 202 is provided to compress the digital audio data. The data buffer 203 for medium data write is a buffer which stores therein the compressed audio data to be later written in the data recording device 204. The data recording device 204 is provided to record therein the compressed audio data.

The digital audio data outputted from the audio data output device 103 is inputted to the ripping apparatus 200G, and temporarily stored in the data buffer 201 for CD signal input. The digital audio data temporarily stored in the data buffer 201 for CD signal input is transferred to the data compression device 202. The data compression device 202 compresses the digital audio data inputted thereto and transfers the compressed audio data to the data buffer 203 for medium data write. The data buffer 203 for medium data write 203 temporarily retains the transferred compressed data. The compressed audio data temporarily retained in the data buffer 203 for medium data write is transferred to the data recording device (recording medium) 204. The data recording device 204 records and stores the transferred compressed data as contents data.

Next, a data flow control for the input data thus ripped is described. As long as a processing speed in the ripping apparatus 200G is materially higher than a speed at which the data is inputted to the ripping apparatus 200G from the CD drive apparatus 100, the data flow control is unnecessary in the ripping apparatus 200G. However, the data buffer 203 for medium data write suspends the data transfer to the data recording device 204 in the event that the data recording device 204 is faced with some difficulty in writing the data in the medium for particular reasons. There are various unfavorable events leading to the difficulty, for example:

the medium is concurrently accessed from any other block;

technical problem derived from the product characteristic of the medium;

individual characteristic difference of the medium; and

unexpected accident on the medium.

There are a few examples of the recording medium that can be installed in the data recording device 204 such as HDD and flash memory. Whatever the medium, it is used in the same system, and there are the same problems to be solved. Therefore, this specification will not spare time and space for description of different media

With difficulty in writing the data in the medium, the compressed data is stored in the data buffer 203 for medium data write until its capacity is full. As soon as the data is stored in the data buffer 203 for medium data write to its full capacity, the transfer of the compressed data from the data compression device 202 to the data buffer 203 is suspended. Similarly, the transfer of the digital audio data from the data buffer 201 for CD signal input to the data compression device 202 is suspended. A volume of the data stored in the data buffer 201 for CD signal input is reported to the optimum speed estimation and decision device 205. The optimum speed estimation and decision device 205 compares the reported data storage volume to a predefined threshold value. Learnt from the comparison that the data storage volume is equal to or larger than the predefined threshold value, the optimum speed estimation and decision device 205 outputs a rotation control signal to the CD rotation control device 101 of the CD drive apparatus 100. The CD rotation control device 101 decelerates the rotational speed of the CD reproduction device 102 based on the inputted rotation control signal. This speed control decelerates an output speed of the digital audio data outputted from the CD drive apparatus 100 to the ripping apparatus 200G. When the data volume in the data buffer 201 for CD signal input is smaller than the threshold value, the optimum speed estimation and decision device 205 outputs a rotation control signal to the CD rotation control device 101. The CD rotation control device 101 accelerates the rotational speed of the CD reproduction device 102 based on the inputted rotation control signal, thereby accelerating the output speed of the digital audio data signal outputted from the CD drive apparatus 100 to the ripping apparatus 200G.

The conventional apparatus still has a problem regardless of the success for higher input speeds. When the rotation control of the CD drive apparatus 100 thus relies on monitoring the data buffer threshold alone, there is only a very short period of time before the data buffer overflow takes place after the data volume equals or exceeds the threshold value that the rotation control then fails to adequately lower the volume of data outputted from the CD drive apparatus 100. Thus, the data output volume is not reduced in time to avoid the buffer overflow, resulting in the system breakdown.

The exemplary embodiments of the present invention which solved the problem are hereinafter described.

### Exemplary Embodiment 1

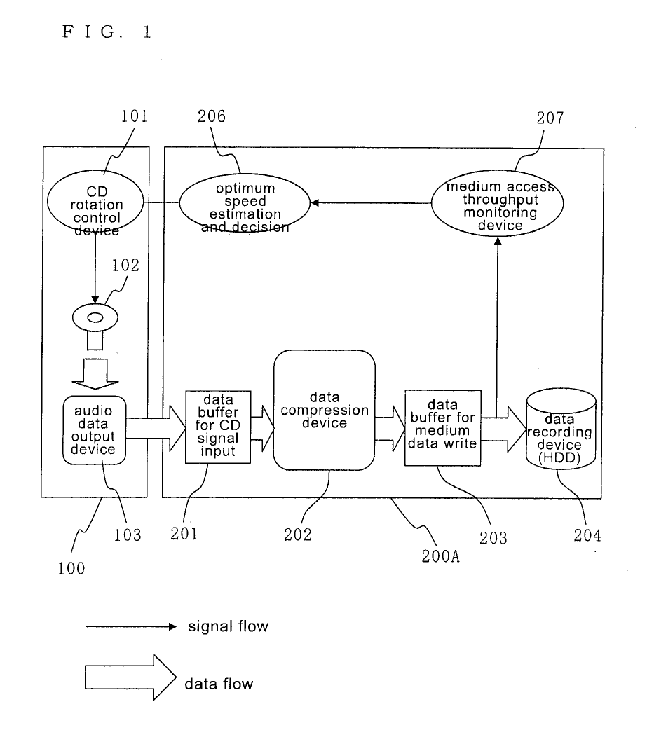

FIGS. 1-3B illustrate a recording and reproduction apparatus according to an exemplary embodiment 1 of the present invention. FIG. 1 is a block diagram illustrating a structure of a ripping apparatus 200A which is the recording and reproduction apparatus according to the present exemplary embodiment. Of the structural elements illustrated in FIG. 1, a CD drive apparatus 100 capable of adjusting a data reproduction volume which is a data of volume to be reproduced per unit time, a data buffer 201 for CD signal input, a data compression device 202, a data buffer 203 for medium data write, and a data recording device 204 are structurally similar to the devices illustrated in FIG. 18. These similar devices will not be described again.

The ripping apparatus 200A is provided with a medium access throughput monitoring device 207. The medium access throughput monitoring device 207 measures an amount of time required to write the data stored in the data buffer 203 for medium data write in the data recording device 204. The medium access throughput monitoring device 207 measures an amount of time for completion of data write every time when the data is written in the recording unit to output a throughput monitor signal which recites therein a medium access throughput (representing a volume of data flow per unit time in recording medium). An optimum speed estimation and decision device 206 records therein the throughput monitor signal supplied from the medium access throughput monitoring device 207 per unit time. The optimum speed estimation and decision device 206 monitors variation of the medium access throughput by analyzing the recorded throughput monitor signal to control an output speed of digital audio data described below (control the data reproduction volume of the CD drive apparatus 100) based on a monitoring result thereby obtained.

In the description of the present exemplary embodiment, the following terms are used.
According to the present exemplary embodiment, a variation of the medium access throughput per unit time is monitored. The variation per unit time is called a throughput variation.
The variation of the medium access throughput includes an upward variation and a downward variation. The throughput variation when the throughput increases is called a throughput variation (upward), the throughput variation when the throughput decreases is called a throughput variation (downward).
The optimum speed estimation and decision device 206 outputs different rotation control signals in dependence upon the different through variations to control the output speed of the audio digital data. The rotation control signal when the throughput variation (upward) is overly generated is called a rotation control signal (lower number of rotations), and the rotation control signal when the throughput variation (downward) is overly generated is called a rotation control signal (higher number of rotations).
To control the rotational speed of the CD reproduction device 102 to higher speeds based on the rotation control signal (higher number of rotations) is called a rotational speed control (higher speed), and to control the rotational speed of the CD reproduction device 102 to lower speeds based on the rotation control signal (higher number of rotations) is called a rotational speed control (lower speed).

The optimum speed estimation and decision device 206 determines whether the throughput variation (upward) or the throughput variation (downward) is overly generated by comparing the throughput variations to threshold values respectively set for the variations. The optimum speed estimation and decision device 206 determines that the respective variations are overly generated when they are equal to or larger than their threshold values.

[Rotation control when the throughput variation (downward) is determined as equal to or larger than its threshold value]

The optimum speed estimation and decision device 206 gives the estimation that “there is a high likelihood of future overflow in the data buffer 201, 203 based on the writing speed of the data recording device 204 slowing down”. Based on the estimation, the optimum speed estimation and decision device 206 outputs the rotation control signal (lower number of rotations) to the CD rotation control device 101 to restrict the volume of data flow from the CD drive apparatus 100. The CD rotation control device 101 which received the rotation control signal (lower number of rotations) lowers the rotational speed of the CD reproduction device 102, and further lowers the output speed of the digital audio data supplied from the CD drive apparatus 100 to the ripping apparatus 200A.

[Rotation control when the throughput variation (upward) is determined as equal to or larger than its threshold value]

The optimum speed estimation and decision device 206 gives the estimation that “the writing speed of the data recording device 204 is accelerating, and it is very likely that there is an enough buffering space in the capacity of the data buffer 201, 203 and the space will increase”. Based on the estimation, the optimum speed estimation and decision device 206 outputs the rotation control signal (higher number of rotations) to the CD rotation control device 101 to accelerate the output speed of the audio data signal outputted from the CD drive apparatus 100. The CD rotation control device 101 which received the rotation control signal (higher number of rotations) accelerates the rotational speed of the CD reproduction device 102, and further accelerates the output speed of the digital audio data supplied from the CD drive apparatus 100 to the ripping apparatus 200A.

The optimum speed estimation and decision device 206 controls the rotation of the CD drive apparatus 100 based on a relationship between the throughput variation and the rate of rotation control for the CD drive apparatus 100. An optimum value of the control rate differs in dependence upon such factors as system configuration and specification.

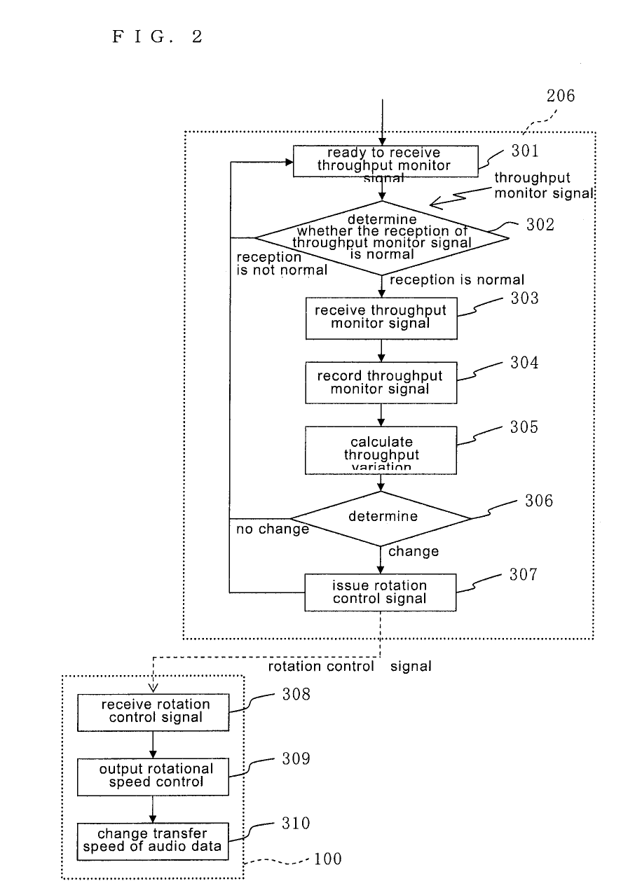

FIG. 2 is a flow chart illustrating processing steps carried out by the optimum speed estimation and decision device 206 and the CD drive apparatus 100. In Step 301, the optimum speed estimation and decision device 206 is ready to receive the throughput monitor signal (standby state). When the optimum speed estimation and decision device 206 starts to receive the throughput monitor signal, the optimum speed estimation and decision device 206 determines in Step 302 the condition of the signal reception. When it is determined in Step 302 that the reception condition is normal, the optimum speed estimation and decision device 206 receives the throughput monitor signal in Step 303. When Step 302 determines the signal reception is undergoing any abnormal condition, the optimum speed estimation and decision device 206 returns to Step 301. The throughput monitor signal received in Step 303 is recorded in Step 304 in the optimum speed estimation and decision device 206. The optimum speed estimation and decision device 206 does not discard the throughput monitor signals recorded in the past but successively stores them over a given period of time. In Step 305, the optimum speed estimation and decision device 206 compares the throughput monitor signal recorded in Step 304 to the past throughput monitor signals to calculate the throughput variation. In Step 306, the optimum speed estimation and decision device 206 determines the throughput variation calculated in Step 305, more specifically, the optimum speed estimation and decision device 206 compares the throughput variation to a predefined threshold value. When it is known from a comparison result thereby obtained that the throughput variation is not equal to or larger than the predefined threshold value, the optimum speed estimation and decision device 206 determines that “there is no considerable rise in the throughput variation, and the medium access throughput is stable”. Then, the optimum speed estimation and decision device 206 immediately returns to Step 301 to continue to monitor the throughput monitor signal.

When it is known from the comparison result that the throughput variation is equal to or larger than the threshold value, the optimum speed estimation and decision device 206 determines that “the medium access throughput is unstably fluctuating from such an excessive throughput variation. Thus determined, the optimum speed estimation and decision device 206 outputs in Step 307 the rotation control signal to the CD rotation control device 101 of the CD drive apparatus 100, and then returns to Step 306 to be ready to receive the throughput monitor signal.

When the CD rotation control device 101 of the CD drive apparatus 100 receives in Step 308 the rotation control signal outputted in Step 307 by the optimum speed estimation and decision device 206, the CD rotation control device 101 outputs a rotational speed control signal to the CD reproduction device 102 in Step S309. In Step S310, the CD reproduction device 102 which received the rotational speed control signal controls a rotational speed for CD reproduction, and the output speed of the audio data signal supplied from the CD drive apparatus 100 to the ripping apparatus 200A is thereby controlled.

As described earlier, the rotation control signal includes the rotation control signal (lower number of rotations) and the rotation control signal (higher number of rotations). When the throughput variation (downward) is equal to or larger than the threshold value indicating a significant drop, the optimum speed estimation and decision device 206 gives the estimation that “the medium access throughput is falling, slowing down the writing speed of the data recording device 204, and there is a high likelihood of future overflow in the data buffer 201, 203”. Based on the estimation, the optimum speed estimation and decision device 206 outputs the rotation control signal (lower number of rotations) in order to restrict the volume of data flow from the CD drive apparatus 100. The CD rotation control device 101 which received the rotation control signal (lower number of rotations) outputs a rotational speed control signal (lower speed) to the CD reproduction device 102 to slow down the rotational speed of the CD reproduction device 102 to slow down the output speed of the digital audio data supplied from the CD drive apparatus 100 to the ripping apparatus 200A.

When the throughput variation (upward) is equal to or larger than the threshold value indicating a significant rise, the optimum speed estimation and decision device 206 gives the estimation that “the medium access throughput is increasing, elevating the writing speed of the data recording device 204, and there is a high likelihood of future overflow in the data buffer 201, 203”. Based on the estimation, the optimum speed estimation and decision device 206 outputs the rotation control signal (higher number of rotations) to the CD rotation control device 101 to accelerate the output speed of the audio data signal outputted from the CD drive apparatus 100. The CD rotation control device 101 which received the rotation control signal (higher number of rotations) outputs a rotational speed control signal (higher speed) to the CD reproduction device 102 to increase the rotational speed of the device, thereby increasing the output speed of the digital audio data supplied from the CD drive apparatus 100 to the ripping apparatus 200A.

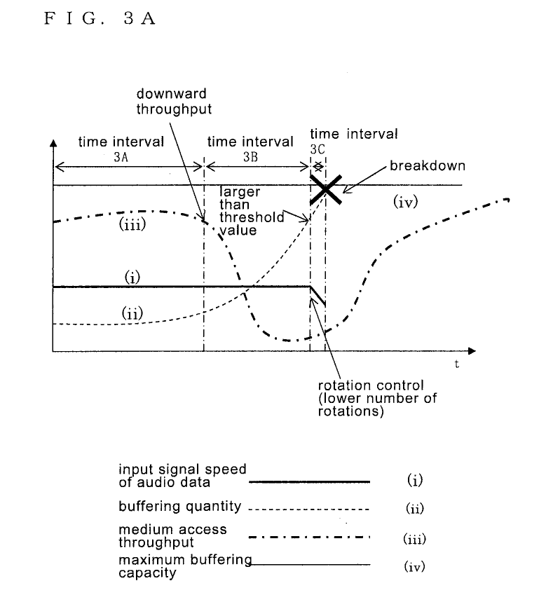

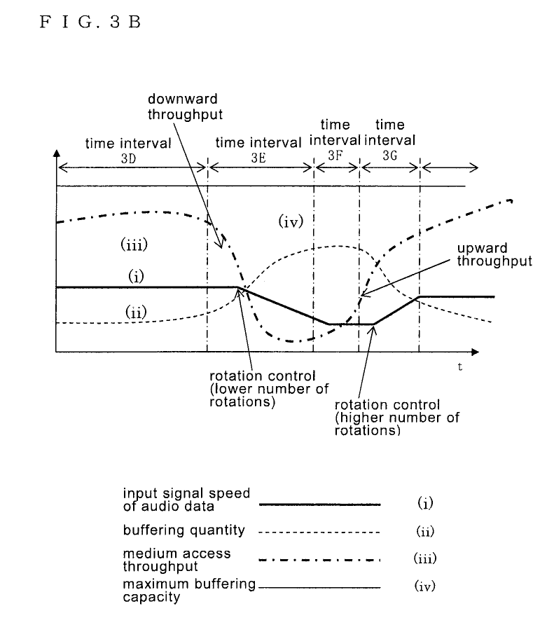

FIG. 3A is a diagram illustrating transitions of; input signal speed of the audio data, buffering quantity, and medium access throughput according to the conventional technology. FIG. 3B is a diagram illustrating transitions of; input signal speed of the audio data, buffering quantity, and medium access throughput according to the present exemplary embodiment. In these drawings, lateral axes represent time.

First, the transitions according to the conventional technology are described. According to the conventional technology, the throughput is controlled through comparison of the buffering quantity to its threshold value.

[Time Interval 3A]

During this time interval, an audio data input signal speed (i) and a medium access throughput (iii) are constant, so is a buffering quantity (ii).

[Time Interval 3B]

During this time interval, the buffering quantity (ii) shows increases in inverse proportion to the medium access through put (iii) sharply dropping, however, the audio data input signal speed (i) remains unchanged.

[Time Interval 3C]

During this time interval, the buffering quantity (ii) is equal to or larger than its threshold value. Therefore, the rotation of the CD drive apparatus 100 is controlled, and the audio data input signal speed (i) starts to fall. The input signal speed (i), however, is not as low as to compensate for the increase of the buffering quantity (ii). Then, the buffering quantity (ii) overflows, resulting in the system breakdown.

Next is described the transitions of the audio data input signal speed (i) and the buffering quantity (ii) according to the present exemplary embodiment when the medium access throughput (iii) undergoes the same transition.

[Time Interval 3D]

During this time interval, the same condition as in the time interval 3A according to the conventional technology is obtained.

[Time Interval 3E]

This time interval is chronologically equal to the time interval 3B according to the conventional technology. During the time interval 3B according to the conventional technology, the rotation of the CD drive apparatus 100 is not controlled because the buffering quantity (ii) stays below its threshold value. In the present exemplary embodiment wherein, on the other hand, the medium access throughput (iii) drops, and the throughput variation (downward) is equal to or larger than its threshold value. The optimum speed estimation and decision device 206 which detected the condition outputs the rotation control signal (lower number of rotations) to perform the rotation control (lower number of rotations) of the CD drive apparatus 100. In consequence of the rotation control, the audio data input signal speed (i) starts to slow down. Because the audio data input signal speed (i) is thus lowered, the buffering quantity (ii) does not increase as much as in the conventional apparatus. Thus, the present exemplary embodiment does not detect the fluctuation of the buffering quantity (ii) but detects the fluctuation of the throughput variation in order to control the rotation of the CD drive apparatus 100, thereby starting the rotation control sooner than the conventional apparatus

[Time Interval 3F]

During this time interval, the downward throughput shows an upward turn. Accordingly, the throughput variation (downward) is generated, however, the throughput variation (downward) stays below its threshold value. The optimum speed estimation and decision device 206 which detected the condition suspends the output of the rotation control signal (lower number of rotations). As a result, the rotational speed of the CD drive apparatus 100 is lower than in the time interval 3D and stays at the speed then, and the audio data input signal speed (i) also remains constant.

[Time Interval 3G]

During this time interval, the medium access throughput (iii) is enhancing, and the throughput variation (upward) equals or exceeds its threshold value. The optimum speed estimation and decision device 206 which detected the condition outputs the rotation control signal (higher number of rotations) to perform the rotation control of the CD drive apparatus 100 (higher number of rotations). As a result, the audio data input signal speed (i) goes upward (increases). To control the rotation for the second time (higher number of rotations), the number of rotations for reproduction during the time interval 3A is set as an upper limit of the number of rotations for reproduction, and the number of rotations for reproduction is no longer controlled as soon as it reaches the number of rotations during the time interval 3A, and the number of rotations at the time is sustained.

As described so far, the present exemplary embodiment adjusts the audio data input signal speed by detecting the throughput variation (indicating the variation of the medium access throughput per unit time). Therefore, the rotation of the CD drive apparatus 100 can be controlled to follow the changing condition of the ripping apparatus 200A, and the audio data can be ripped at an optimum speed.

### Exemplary Embodiment 2

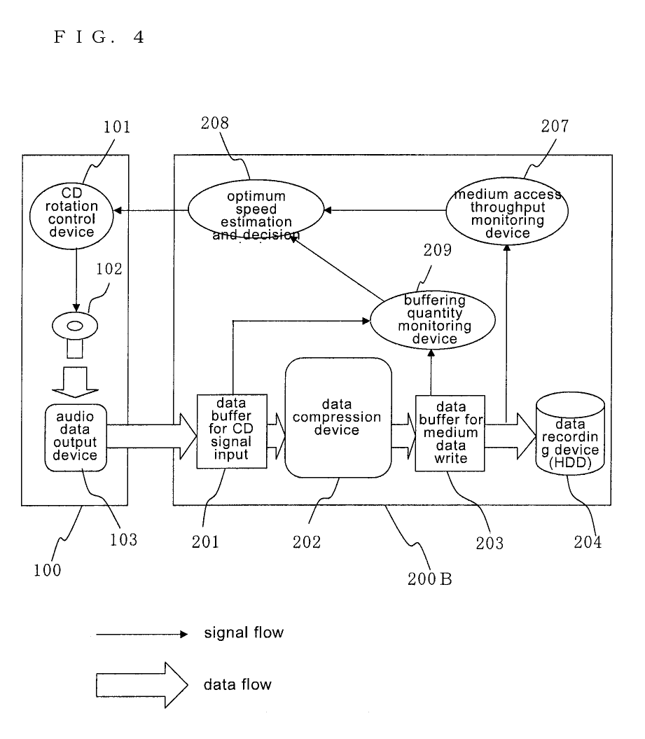

A recording and reproduction apparatus according to an exemplary embodiment 2 of the present invention is described below referring to FIGS. 4-6. FIG. 4 is a block diagram illustrating a structure of a CD ripping apparatus 200B which is the recording and reproduction apparatus according to the present exemplary embodiment. The description given below does not refer to devices illustrated in FIG. 4 structurally similar to those described in the exemplary embodiment 1, which are a CD drive apparatus 100, a data buffer 201 for CD signal input, a data compression device 202, a data buffer 203 for medium data write, a data recording device 204, and a medium access throughput monitoring device 207.

The ripping apparatus 200B is provided with an optimum speed estimation and decision device 208 and a buffering quantity monitoring device 209. The buffering quantity monitoring device 209 monitors a buffering quantity in the data buffer 201 for CD signal input and a buffering quantity in the data buffer 203 for medium data write. The buffering quantity monitoring device 209 outputs a monitoring result thus obtained in the form of a buffering quantity monitor signal. The optimum speed estimation and decision device 208 records therein the throughput monitor signal supplied from the medium access throughput monitoring device 207 and the buffering quantity monitor signal supplied from the buffering quantity monitoring device 209 per unit time. The optimum speed estimation and decision device 208 monitors variation of the buffering quantity monitor signals and variation of the throughput monitor signals respectively per unit time.

Monitoring these signals, the optimum speed estimation and decision device 208 compares the throughput variation to its threshold value, and also compares the buffering quantity variation per unit time based on the buffering quantity monitor signal (hereinafter, called buffering quantity variation) to its threshold value. In the description below, similarly to the through variations, the buffering quantity variation when the buffering quantity is decreasing is called a buffering quantity variation (downward), and the buffering quantity when the buffering quantity is increasing is called a buffering quantity variation (upward).

When the compared throughput variation (downward) is equal to or larger than its threshold value, the optimum speed estimation and decision device 208 determines that the medium access throughput is overly deteriorating, and gives the estimation therefrom that “there is a high likelihood of future overflow in the data buffer 201, 203”. When the compared buffering quantity variation (upward) is equal to or larger than its threshold value, the optimum speed estimation and decision device 208 similarly gives the estimation that “medium access throughput is going down in any of the blocks, and the data buffer 201, 203 is likely to overflow later”. The optimum speed estimation and decision device 208 can determine that the medium access throughput is deteriorating whichever of the throughput variation (downward) and the buffering quantity variation (upward) is equal to or larger than the relevant threshold value. However, when these two variations and their comparison results are combined, the variation of the medium access throughput can be more accurately determined.

Based on the estimation, the optimum speed estimation and decision device 208 outputs the rotation control signal (lower number of rotations) to the CD rotation control device 101 in order to restrict the volume of dataflow from the CD drive apparatus 100. The CD rotation control device 101 outputs the rotational speed control signal (lower speed) to the CD reproduction device 102 based on the rotation control signal (lower number of rotations) supplied from the optimum speed estimation and decision device 208 to perform the rotation control (lower number of rotations) of the CD reproduction device 102. This rotation control lowers the output speed of the CD data to the ripping apparatus 200B.

Having detected that the throughput variation (upward) is equal to or larger than its threshold value, the optimum speed estimation and decision device 208 gives the estimation that “the writing speed of the data recording device 204 is accelerating, and it is very likely that there is an enough buffering space in the capacity of the data buffer 201, 203 and the space will increase”. Having detected that the throughput variation (downward) is equal to or larger than its threshold value, the optimum speed estimation and decision device 208 gives the estimation that “the medium access throughput is increasing, elevating the writing speed of the data recording device 204, and there is a high likelihood of future overflow in the data buffer 201, 203”.

Based on the estimation, the optimum speed estimation and decision device 208 outputs the rotation control signal (higher number of rotations) to the CD rotation control device 101 in order to increase the volume of dataflow from the CD drive apparatus 100. Based on the inputted rotation control signal (higher number of rotations), the CD rotation control device 101 outputs the rotational speed control signal (higher speed) to the CD reproduction device 102 to perform the rotation control (higher number of rotations). In response to the rotation control, the CD reproduction device 102 accelerates (increases) the rotational speed for CD reproduction to improve the output speed of CD data supplied to the ripping apparatus 200B.

Different systems have different optimum values for the buffering quantity variation in the data buffer 201, 203, and the rate of rotation control for the CD drive apparatus 100. Further, the buffering quantity monitoring device 209 not only monitors the data buffer 203 for medium data write but also monitors the data buffer 201 for CD signal input so as to readily reduce the audio data input speed due when some event occurs in the data compression device 202.

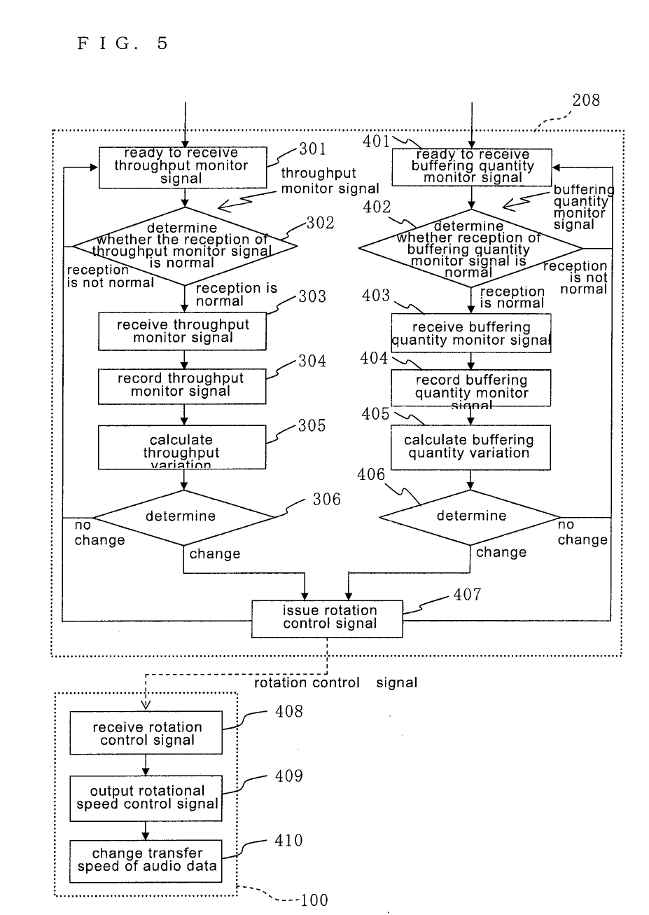

FIG. 5 is a flow chart illustrating processing steps carried out by the optimum speed estimation and decision device 208 and the CD drive apparatus 100. Steps 301-306 are similar to the processing steps described referring to FIG. 2 according to the exemplary embodiment 1, and will not be described below.

In Step 401, the optimum speed estimation and decision device 208 is ready to receive the buffering quantity monitor signal (standby state). When the optimum speed estimation and decision device 208 starts to receive the buffering quantity monitor signal, the optimum speed estimation and decision device 208 determines in Step 402 the condition of the signal reception. When it is determined in Step 402 that the reception condition is normal, the optimum speed estimation and decision device 208 receives the buffering quantity monitor signal in Step 403. When Step 403 determines the signal reception is undergoing any abnormal condition, the optimum speed estimation and decision device 208 returns to Step 401. The buffering quantity monitor signal received in Step 403 is recorded in Step 404 in the optimum speed estimation and decision device 208. The optimum speed estimation and decision device 208 does not discard the buffering quantity monitor signals recorded in the past but successively stores them over a given period of time. In Step 405, the optimum speed estimation and decision device 208 compares the buffering quantity monitor signal recorded in Step 404 to the past buffering quantity monitor signals to calculate the buffering quantity variation. Further, in Step 406, the optimum speed estimation and decision device 208 determines the buffering quantity variation calculated in Step 405, more specifically, the optimum speed estimation and decision device 208 compares the buffering quantity variation to a predefined threshold value. When it is known from a comparison result thereby obtained that the buffering quantity variation is not equal to or larger than the threshold value, the optimum speed estimation and decision device 208 determines that “there is no considerable rise in the buffering quantity variation so far, and the medium access throughput is stable”. Then, the optimum speed estimation and decision device 208 immediately returns to Step 401 to continue to monitor the buffering quantity monitor signal.

When it is known from the comparison results of Steps 306 and 406 that the throughput variation or the buffering quantity variation is equal to or larger than the relevant threshold value, the optimum speed estimation and decision device 208 determines that “the throughput variation or the buffering quantity variation is overly fluctuating, and the medium access throughput is also unstably fluctuating. Thus determined, the optimum speed estimation and decision device 208 outputs in Step 407 the rotation control signal to the CD rotation control device 101, and then returns to Step 301 (standby state for the reception of the throughput monitor signal) or Step 401 (standby state for the reception of the buffering quantity monitor signal.

The rotation control signal outputted by the optimum speed estimation and decision device 208 in Step 407 is received by the CD rotation control device 101 in Step S408. When the CD rotation control device 101 receives the rotation control signal, the CD rotation control device 101 outputs in Step 409 the rotational speed control signal to the CD reproduction device 102. In Step 410, the CD reproduction device 102 controls the rotational speed for CD reproduction based on the supplied rotational speed control signal. Accordingly, the output signal speed of the audio data supplied from the CD drive apparatus 100 to the ripping apparatus 200A is controlled.

As described earlier, the rotation control signal includes the rotation control signal (lower number of rotations) and the rotation control signal (higher number of rotations). When the throughput variation (downward) or the buffering quantity variation (upward) is equal to or larger than the relevant threshold value, the optimum speed estimation and decision device 208 gives the estimation that “the medium access throughput is deteriorating, slowing down the writing speed of the data recording device 204, and there is a high likelihood of future overflow in the data buffer 201, 203”. Based on the estimation, the optimum speed estimation and decision device 208 outputs the rotation control signal (lower number of rotations) in order to restrict the volume of data flow from the CD drive apparatus 100. The CD rotation control device 101 which received the rotation control signal (lower number of rotations) slows down the rotational speed of the CD reproduction device 102 to decrease the output speed of the digital audio supplied from the CD drive apparatus 100 to the ripping apparatus 200A.

When the throughput variation (upward) or the buffering quantity variation (downward) is equal to or larger than the relevant threshold value, the optimum speed estimation and decision device 208 gives the estimation that “the medium access throughput is increasing, accelerating the writing speed of the data recording device 204, and it is very likely that there is an enough buffering space in the data buffer 201, 203 and the space will increase”. Based on the estimation, the optimum speed estimation and decision device 208 outputs the rotation control signal (higher number of rotations) in order to increase the signal output speed of the audio data supplied from the CD drive apparatus 100. The CD rotation control device 101 which received the rotation control signal (higher number of rotations) performs the rotational speed control (higher speed) to control the rotational speed of the CD reproduction device 102 (higher speed), so that the output speed of the digital audio supplied from the CD drive apparatus 100 to the ripping apparatus 200A is increased.

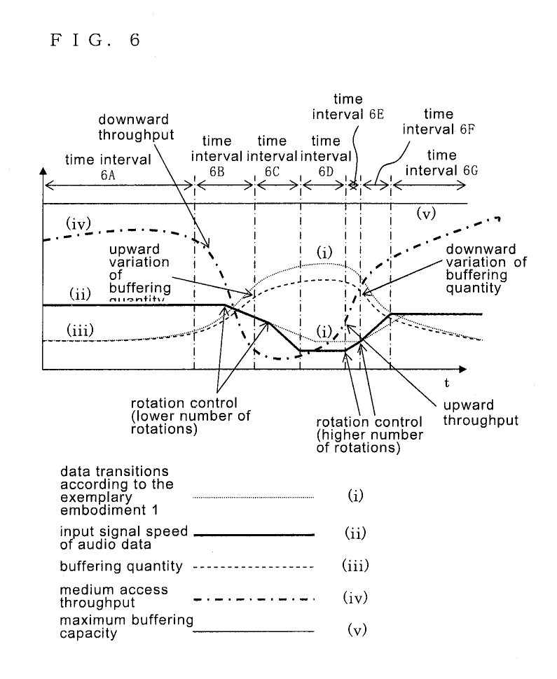

FIG. 6 is a diagram illustrating transitions of the input signal speed of audio data, buffering quantity, and medium access throughput according to the present exemplary embodiment.

[Time Interval 6A]

During this time interval, the same condition as in the time interval 3D according to the exemplary embodiment 1 is obtained.

[Time Interval 6B]

During this time interval, a medium access throughput (iv) decreases, and the throughput variation (downward) equals or exceeds its threshold value. The optimum speed estimation and decision device 208 which detected the condition outputs a first rotation control signal (lower number of rotations) to perform a first rotation control (lower number of rotations) of the CD drive apparatus 100. As a result of the rotation control, an audio data input signal speed (ii) decreases. During this time interval, the buffering quantity increases, while the buffering quantity variation (upward) stays below its threshold value.

[Time Interval 6C]

During this time interval, the medium access throughput is stable near a minimum value, and the throughput variation (downward) is as close to zero as possible. However, the buffering quantity variation (upward) equals or exceeds its threshold value. The optimum speed estimation and decision device 208 which detected the condition outputs a second rotation control signal (lower number of rotations) to perform a second rotation control (lower number of rotations) of the CD drive apparatus 100. The rotation is controlled so that a rate of change of the rotational speed generated by the second rotation control (lower number of rotations) is larger than a rate of change of the rotational speed generated by the first rotation control (lower number of rotations). As a result of the second rotation control, the audio data input signal speed (ii) drops more quickly than in the time interval 6B. The exemplary embodiment 1 does not perform the rotation control thus advantageous. According to the present exemplary embodiment which provides such a rotation control, the buffering quantity does not increase as much as in the exemplary embodiment 1.

[Time Interval 6D]

During this time interval, the downward medium access throughput (iv) shows an upward turn, and the throughput variation (upward) is generated. The buffering quantity (downward), on the other hand, is close to zero as possible. However, the throughput variation (upward) and the buffering quantity variation (downward) both stay below their threshold values. The optimum speed estimation and decision device 208 which detected the condition suspends the output of the second rotation control signal (lower number of rotations). Correspondingly, the CD rotation control device 101 suspends the second rotation control (lower number of rotations) and keeps the rotational speed at the time. As a result, the rotational speed of the CD drive apparatus 100 is lower than in the time interval 3F according to the exemplary embodiment 1 and stays at the speed, and the audio data input signal speed (i) also remains constant.

[Time Interval 6E]

During this time interval, the throughput variation (upward) equals or exceeds its threshold value. The upward buffering quantity shows a downward turn, and the buffering quantity variation (downward) is generated. The buffering quantity variation (downward), however, still stays below its threshold value. The optimum speed estimation and decision device 208 detects that the throughput variation (upward) is equal to or larger than its threshold value. Then, the optimum speed estimation and decision device 208 outputs the first rotation control signal (higher number of rotations) to the CD reproduction device 102 to perform the first rotation control (higher number of rotations), so that the audio data input signal speed (ii) is increased.

[Time Interval 6F]

During this time interval, the throughput variation (upward) styas equal to or larger than its threshold value, and the buffering quantity variation (downward) also stays equal to or exceeds its threshold value. The optimum speed estimation and decision device 208 detects that the throughput variation (upward) and the buffering quantity variation (downward) both equal or exceed their threshold values. Then, the optimum speed estimation and decision device 208 outputs the second rotation control signal (higher number of rotations) to the CD reproduction device 102 to perform the second rotation control (higher number of rotations), so that the audio data input signal speed (ii) is further enhanced (increased). The rotation is controlled so that a rate of change of the rotational speed generated by the second rotation control (higher number of rotations) is larger than a rate of change of the rotational speed generated by the first rotation control (higher number of rotations). As a result of the second rotation control, the audio data input signal speed (ii) rise more sharply than in the time interval 6E.

[Time Interval 6G]

During this time interval, the throughput variation (upward) and the buffering quantity variation (downward) are both below their threshold values. The optimum speed estimation and decision device 208 which detected the condition suspends the output of the second rotation control signal (higher number of rotations), and the rotational speed of the CD drive apparatus 100 stays at the speed equal to that of the time interval 6A. In the second rotation control (higher number of rotations), the number of rotations for reproduction in the CD reproduction device 102 is controlled with the number of rotations for reproduction during the time interval 6A used as an upper limit of the number of rotations. When the number of rotations reaches that of the time interval 6A, the rotation control is suspended so that the number of rotations for reproduction at the time is sustained. The decision to suspend the rotation control is concurrent with the decision to suspend the second rotation control (higher number of rotations) based on the comparison of the throughput variation (upward) and the buffering quantity variation (downward) to their threshold values. The second rotation control (higher number of rotations) is suspended based on one of the decision results.

According to the present exemplary embodiment, the rotational speed of the CD drive apparatus is controlled in a shorter period of time than in the exemplary embodiment 1. Therefore, maximum values of the buffering quantity indicating the largest volumes of data that can be stored in the respective buffers can be reduced.

As described so far, the present exemplary embodiment is technically advantageous in that the audio data input signal speed is adjusted by comparing the throughput variation to its threshold value and comparing the buffering quantity variation to its threshold value. Therefore, the rotational speed of the CD drive apparatus can be controlled in such a manner that is more suitable for the condition of the ripping apparatus 200B. As a result, the audio data can be ripped at an optimum speed.

In the description of the exemplary embodiment 2 given so far, the optimum speed estimation and decision device 208 generates the rotation control signal (the signal which controls the volume of dataflow outputted from the CD drive apparatus 100 to the data buffer 201 for CD signal input) based on the following first-third parameters, and outputs the generated rotation control signal to the CD rotation control device 101;
first parameter: throughput variation (volume of dataflow per unit to the data recording device 204,
second parameter: buffering quantity variation in the data buffer 201 for CD signal input (buffering quantity variation per unit time), and
third parameter: buffering quantity variation in the data buffer 203 for medium data write (buffering quantity variation per unit time).

The rotation control signal may be generated, for example, as defined below;
the rotation control signal is generated based on the second parameter alone,
the rotation control signal is generated based on the second and third parameters,
the rotation control signal is generated based on the third parameter alone,
the rotation control signal is generated based on the first and second parameters, or
the rotation control signal is generated based on the first and third parameters.

### Exemplary Embodiment 3

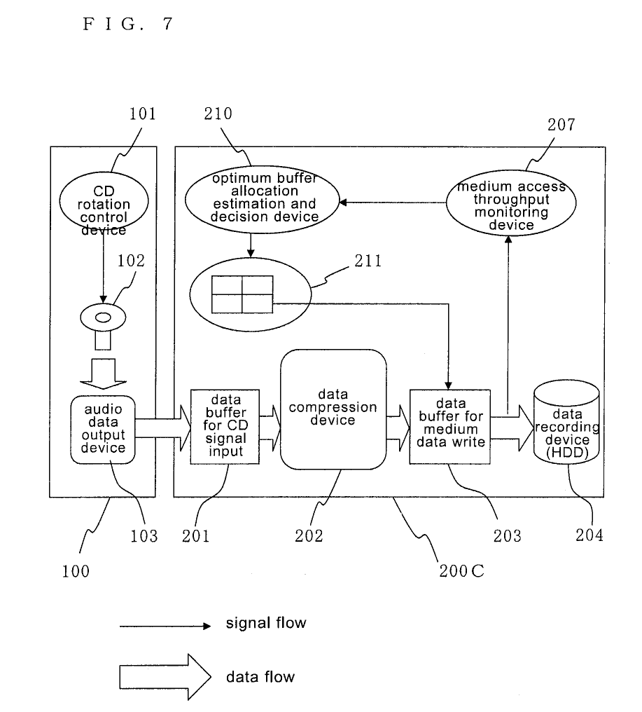

A recording and reproduction apparatus according to an exemplary embodiment 3 of the present invention is described referring to FIGS. 7-9. FIG. 7 is a block diagram illustrating a structure of a CD ripping apparatus 200C which is the recording and reproduction apparatus according to the present exemplary embodiment. The description given below does not refer to devices illustrated in FIG. 7 structurally similar to those described in the exemplary embodiment 1, which are a CD drive apparatus 100, a data buffer 201 for CD signal input, a data compression device 202, a data buffer 203 for medium data write, a data recording device 204, and a medium access throughput monitoring device 207.

The ripping apparatus 200C is further provided with a backup buffer management device 211 and an optimum buffer allocation estimation and decision device 210. The backup buffer management device 211 includes a buffer which can be attached to the data buffer 203 for medium data write or the data buffer 201 for CD signal input to provide a backup storage (hereinafter, called backup buffer), and a connection management unit for controlling connection of the backup buffer to the data buffer 203 for medium data write or the data buffer 201 for CD signal input (connection or disconnection of the backup buffer).

The optimum buffer allocation estimation and decision device 210 estimates the transitional buffering quantity in the data buffer 203 for medium data write or the transitional buffering quantity in the data buffer 201 for CD signal input based on the monitoring result obtained by the medium access throughput monitoring device 207, and allocates the backup buffer of the backup buffer management device 211 to the data buffer 203 for medium data write or the data buffer 201 for CD signal input based on an estimation result thus obtained. Below is described an example of the allocation process.

The optimum buffer allocation estimation and decision device 210 records therein the throughput monitor signal supplied from the medium access throughput monitoring device 207 per unit time. The optimum buffer allocation estimation and decision device 210 monitors changes detected in the throughput monitor signals each recorded per unit time. The optimum buffer allocation estimation and decision device 210, which detected a significant drop in the medium access throughput by comparing the throughput variation to its threshold value, gives the estimation that there is a high likelihood of future overflow in the data buffer 201, 203.

Based on the estimation, the optimum buffer allocation estimation and decision device 210 outputs a backup buffer allocation signal (increase) to the backup buffer management device 211. When the backup buffer allocation signal (increase) is received by the backup buffer management device 211, the backup buffer management device 211 allocates the backup buffer thereby managed to the data buffer 203 for medium data write based on the backup buffer allocation signal (increase).

The optimum buffer allocation estimation and decision device 210, which detected a significant rise in the medium access throughput by comparing the throughput variation to its threshold value, gives the estimation that “the writing speed of the data recording device 204 is accelerating, and it is very likely that there is an enough buffering space in the capacity of the data buffer 201, 203 and the space will increase”.

Based on the estimation, the optimum buffer allocation estimation and decision device 210 outputs a backup buffer allocation signal (decrease) to the backup buffer management device 211. When the backup buffer allocation signal (decrease) is supplied from the optimum buffer allocation estimation and decision device 210 to the backup buffer management device 211, the backup buffer management device 211 detaches the backup buffer allocated to the data buffer 203 for medium data write therefrom based on the received backup buffer allocation signal (decrease) so that the backup buffer can be returned (return of the backup buffer).

Though the operation described so far is performed in the case where the backup buffer is allocated to the data buffer 203 for medium data write, a similar effect can be obtained in the case where the backup buffer is allocated to the data buffer 201 for CD signal input. However, it is more desirable to allocate the backup buffer to the data buffer 203 for medium data write where compressed data can be processed than allocating the backup buffer to the data buffer 201 for CD signal input which handles non-compressed data because the backup buffer allocated to the data buffer 203 can more effectively support the same buffering quantity over a longer period of time.

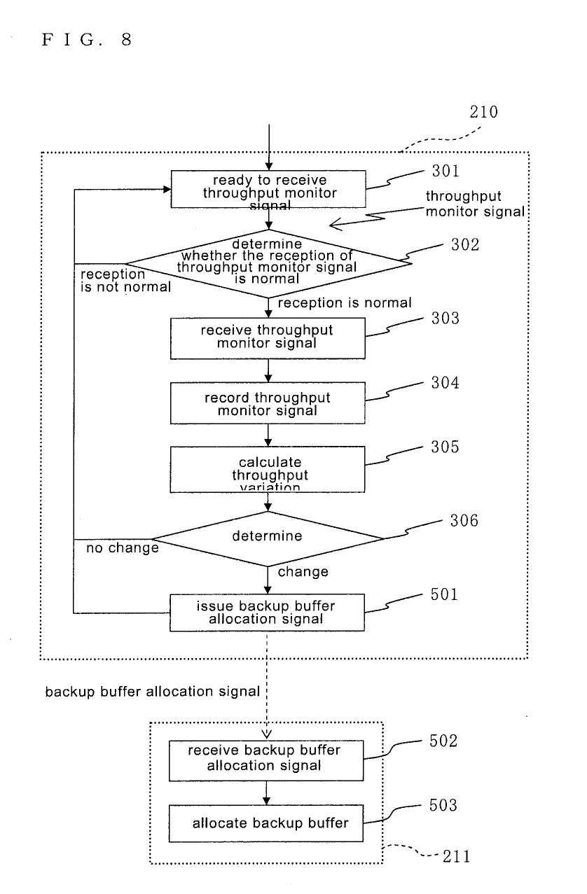

FIG. 8 is a flow chart illustrating processing steps carried out by the optimum buffer allocation estimation and decision device 210 and the backup buffer management device 211. The description given below skip Steps 301-306 which are similar to those described in the exemplary embodiment 1.

In Step 306, the optimum buffer allocation estimation and decision device 210 determines the throughput variation calculated in Step S305. When it is determined in Step 306 that the throughput variation is below its threshold value, the optimum buffer allocation estimation and decision device 210 returns to Step 301. When the optimum buffer allocation estimation and decision device 210 determines in Step 306 that the throughput variation is equal to or larger than its threshold value, the optimum buffer allocation estimation and decision device 210 outputs in Step 501 the backup buffer allocation signal (increase or decrease) to the backup buffer management device 211, and returns to Step 301. The backup buffer allocation signal outputted in Step 501 is received in Step 502 by the backup buffer management device 211. The backup buffer management device 211 which received the backup buffer allocation signal adjusts a backup buffering quantity (quantity to be allocated) of the data buffer 203 for medium data write. There are two different adjustments; the buffering quantity is adjusted by allocating the backup buffer of the backup buffer management device 211 to the data buffer 203 for medium data write, and the buffering quantity is adjusted by returning the backup buffer from the data buffer 203 for medium data write to the backup buffer management device 211.

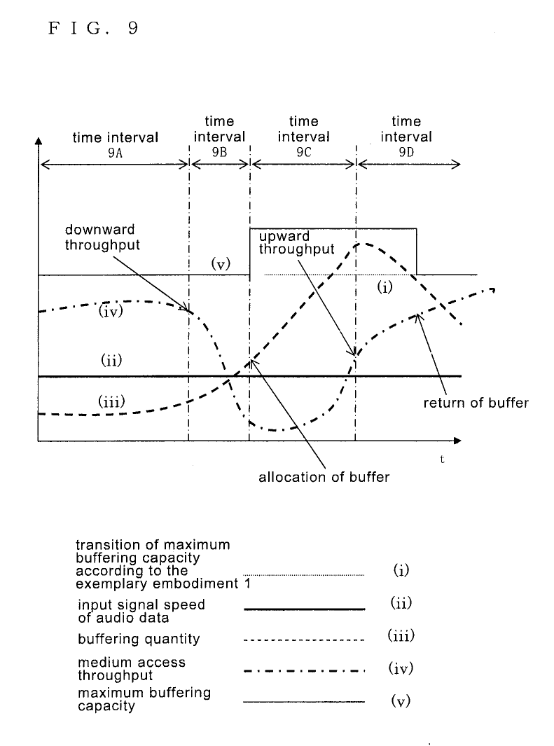

FIG. 9 is a diagram illustrating transitions of the input signal speed of audio data, buffering quantity, and medium access throughput according to the present exemplary embodiment.

[Time Interval 9A]

During this time interval, the same condition as in the time interval 3D according to the exemplary embodiment is obtained.

[Time Interval 9B]

During this time interval, the medium access throughput (iv) drops, and the throughput variation (downward) equals or exceeds its threshold value. The optimum buffer allocation estimation and decision device 210 which detected the condition outputs the backup buffer allocation signal (increase) to the backup buffer management device 211. Based on the backup buffer allocation signal (increase), the backup buffer management device 211 allocates the backup buffer to the data buffer 203 for medium data write, and the data buffer 203 for medium data write increases a maximum buffering capacity (v) thereof. The backup buffer is actually allocated to the data buffer 203 for medium data write in an initial stage of the next time interval 9C.

[Time Interval 9C]

This time interval corresponds to the time intervals 3B and 3C according to the conventional technology. During this time interval, the downward throughput shows an upward turn. The technical problem of the conventional technology is the overflow of the buffering quantity (ii) during this time interval, resulting in the system breakdown. To solve the technical problem, the present exemplary embodiment increases the maximum buffering capacity (v) of the data buffer 203 for medium data write during the time interval 9B so that the increasing buffering quantity (ii) is well accepted. Therefore, the buffering quantity (ii) may increase beyond the conventional maximum buffering capacity (v) toward the end of this time interval, however, the risk of system breakdown can be avoided because the increased maximum burring capacity (v) is larger than a peak value of the increased buffering quantity.

[Time Interval 9D]

Since there is no system breakdown during the time interval 9C, the downward medium access throughput (iv) shows an upward turn (improvement) from around a terminal stage of the time interval 9C to an initial stage of a time interval 9D. Along with the elevation of the medium access throughput (iv), the throughput variation (upward) equal or exceeds its threshold value at a discretionary time point. The optimum buffer allocation estimation and decision device 210 which detected the condition outputs the backup buffer allocation signal (decrease) to the backup buffer management device 211. Based on the backup buffer allocation signal (decrease), the backup buffer management device 211 detaches the backup buffer allocated to the data buffer 203 for medium data write therefrom so that the backup buffer can be returned (return of the backup buffer). Then, the maximum buffering capacity of the data buffer 203 for medium data write decreases to optimally set the capacity (v) of the data buffer 203 for medium data write.

As describer so far, the present exemplary embodiment is technically advantageous in that the data buffering quantity (maximum buffering capacity) is adjusted depending on the throughput variation. In the case where the writing speed temporarily slows down owing to some trouble occurring in the recording medium, therefore, the number of rotations of the CD drive apparatus 100 can be constantly sustained when the audio data is ripped.

### Exemplary Embodiment 4

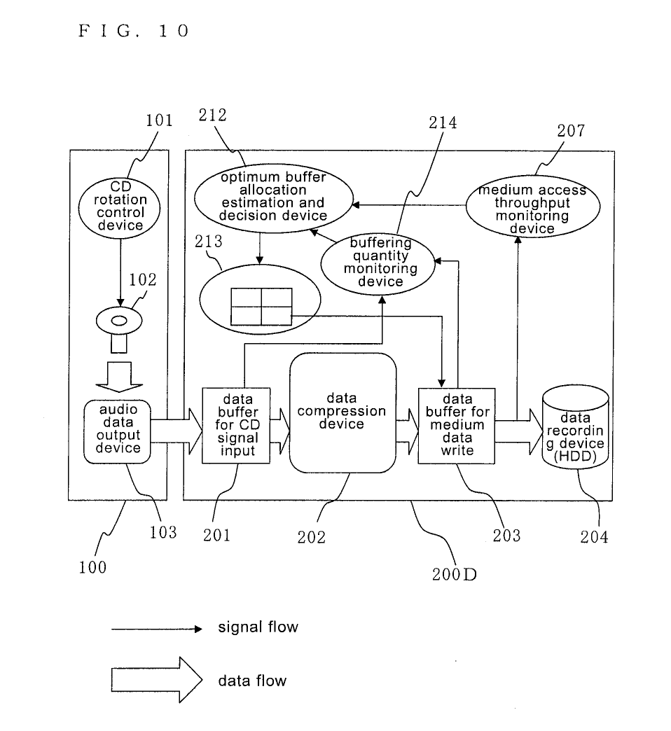

A recording and reproduction apparatus according to an exemplary embodiment 4 of the present invention is described referring to FIGS. 10-12. FIG. 10 is a block diagram illustrating a structure of a CD ripping apparatus 200D which is the recording and reproduction apparatus according to the present exemplary embodiment. The description given below does not refer to devices illustrated in FIG. 10 structurally similar to those described in the exemplary embodiment 1, which are a CD drive apparatus 100, a data buffer 201 for CD signal input, a data compression device 202, a data buffer 203 for medium data write, a data recording device 204, and a medium access throughput monitoring device 207.

The ripping apparatus 200D is further provided with an optimum buffer allocation estimation and decision device 212, a backup buffer management device 213, and a buffering quantity monitoring device 214. The buffering quantity monitoring device 214 monitors the buffering quantity in the data buffer 201 for CD signal input and the buffering quantity in the data buffer 203 for medium write data. The buffering quantity monitoring device 214 outputs a monitoring result thereby obtained in the form of a buffering quantity monitor signal. The optimum buffer allocation estimation and decision device 212 records therein the throughput monitor signal supplied from the medium access throughput monitoring device 207 and the buffering quantity monitor signal supplied from the buffering quantity monitoring device 214 per unit time. The optimum buffer allocation estimation and decision device 212 analyzes changes of the throughput monitor signals each recorded per unit time and changes of the buffering quantity monitor signals each recorded per unit time to monitor the throughput variation and the buffering quantity variation, and controls the allocation of the backup buffer based on a monitoring result thus obtained as described below.

Having detected that the throughput variation (downward) or the buffering quantity variation (upward) is equal to or larger than the relevant threshold value, the optimum buffer allocation estimation and decision device 212 determines a considerable drop in the throughput of any block, based on which the optimum buffer allocation estimation and decision device 212 gives the estimation that “there is a high likelihood of future overflow in the data buffer 201, 203”.

Based on the estimation, the optimum buffer allocation estimation and decision device 212 outputs the backup buffer allocation signal (increase) to the backup buffer management device 213. In response to the supply of the backup buffer allocation signal (increase), the backup buffer management device 213 allocates the backup buffer thereby managed to the data buffer 203 for medium data write based on the supplied backup buffer allocation signal (increase).

When the optimum buffer allocation estimation and decision device 212 compares the throughput variation to its threshold value or compares the buffering quantity variation to its threshold value and learns from the comparison that the medium access throughput is overly elevating, the optimum buffer allocation estimation and decision device 212 gives the estimation that “the writing speed of the data recording device 204 is accelerating, and it is very likely that there is an enough buffering space in the capacity of the data buffer 201, 203 and the space will increase”.

Based on the estimation, the optimum buffer allocation estimation and decision device 212 outputs the backup buffer allocation signal (decrease) to the backup buffer management device 213. When the backup buffer allocation signal (decrease) is supplied from the optimum buffer allocation estimation and decision device 212 to the backup buffer management device 213, the backup buffer management device 213 detaches the backup buffer allocated to the data buffer 203 for medium data write therefrom so that the backup buffer can be returned (return of the backup buffer).

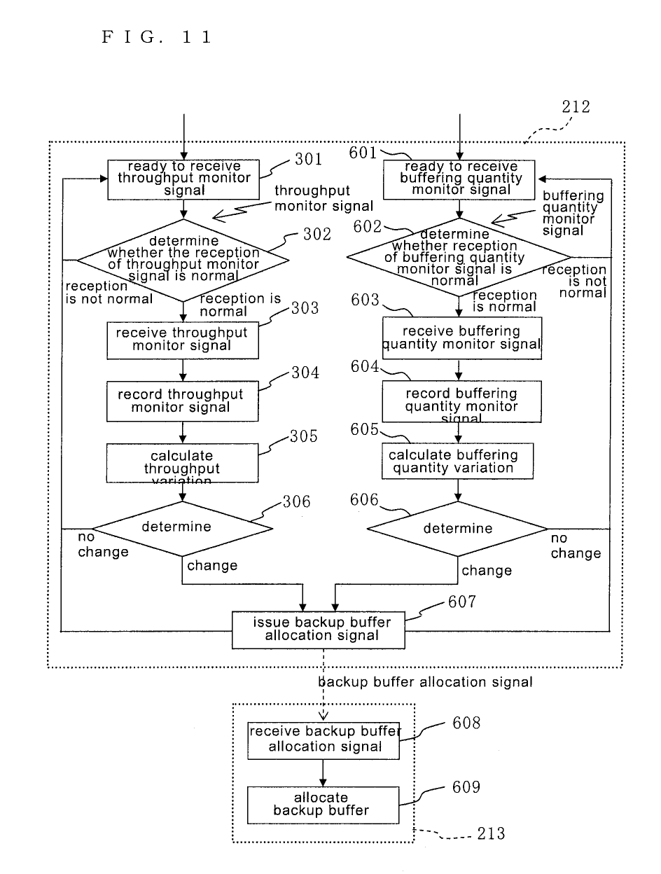

FIG. 11 is a flow chart illustrating processing steps carried out by the optimum buffer allocation estimation and decision device 212 and the backup buffer management device 213. Steps 301-306 are similar to the processing steps described in the exemplary embodiment 1, and will not be described below.

In Step 601, the optimum buffer allocation estimation and decision device 212 is ready to receive the buffering quantity monitor signal (standby state). When the optimum buffer allocation estimation and decision device 212 starts to receive the buffering quantity monitor signal, the optimum buffer allocation estimation and decision device 212 determines in Step 602 the condition of the signal reception. When it is determined in Step 602 that the reception condition is normal, the optimum buffer allocation estimation and decision device 212 receives the buffering quantity monitor signal in Step 603. When Step 602 determines the signal reception is undergoing any abnormal condition, the optimum buffer allocation estimation and decision device 212 returns to Step 601. The buffering quantity monitor signal received in Step 603 is recorded in Step 604 in the optimum buffer allocation estimation and decision device 212. The optimum buffer allocation estimation and decision device 212 does not discard the buffering quantity monitor signals recorded in the past but successively stores them over a given period of time. In Step 605, the optimum buffer allocation estimation and decision device 212 compares the buffering quantity monitor signal recorded in Step 604 to the past buffering quantity monitor signals to calculate the buffering quantity variation. In Step 606, the optimum buffer allocation estimation and decision device 212 determines the buffering quantity variation calculated in Step 605, more specifically, the optimum buffer allocation estimation and decision device 212 compares the buffering quantity variation to a predefined threshold value. When it is known from a comparison result thereby obtained that the buffering quantity variation is not equal to or larger than the threshold value, the optimum buffer allocation estimation and decision device 212 determines that “there is no considerable rise in the buffering quantity variation, and the medium access throughput is stable”. Then, the optimum buffer allocation estimation and decision device 212 immediately returns to Step 601 to continue to monitor the buffering quantity monitor signal.

Learnt from the comparison result of Step 306 or Step 606 that the throughput variation or the buffering quantity variation is equal to or larger than the relevant threshold value, the optimum buffer allocation estimation and decision device 212 determines that “the medium access throughput is unstably changing according to the fluctuation of the throughput variation or the buffering quantity variation. Accordingly, in Step 607, the optimum buffer allocation estimation and decision device 212 outputs the backup buffer allocation signal to the backup buffer management device 213, and returns to Step 301 (ready to receive the throughput monitor signal) and Step 601 (ready to receive the buffering quantity monitor signal).

The backup buffer allocation signal outputted in Step 607 from the optimum buffer allocation estimation and decision device 212 is received in Step 608 by the backup buffer management device 213. The backup buffer management device 213 receives the backup buffer allocation signal, and adjusts in Step 608 the buffering quantity of the backup buffer to be allocated to the data buffer 203 for medium data write. There are two different adjustments; the buffering quantity is adjusted by allocating the backup buffer of the backup buffer management device 211 to the data buffer 203 for medium data write, and the buffering quantity is adjusted by returning the backup buffer from the data buffer 203 for medium data write to the backup buffer management device 211.

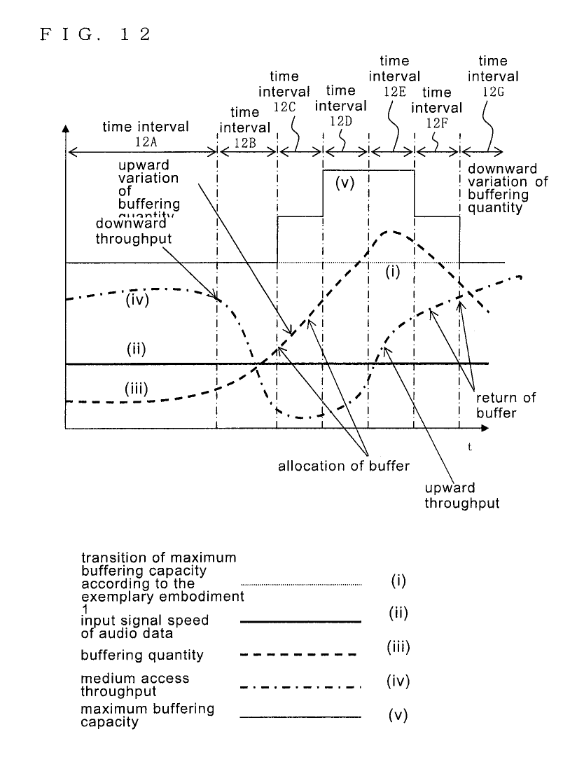

FIG. 12 is a diagram illustrating transitions of the input signal speed of audio data, buffering quantity, and medium access throughput according to the present exemplary embodiment. In a time interval 12A, a time interval 12B, and a time interval 12C respectively, conditions substantially the same as the time interval 9A, time interval 9B, and the first half of the time interval 9C according to the exemplary embodiment 3 (see FIG. 9) are obtained. More simply illustrating the conditions in the respective time intervals,

time interval 12A=time interval 9A

time interval 12B=time interval 9B, and

time interval 12C=first half of time interval 9C.

A more specific description is given below.

[Time Interval 12A]

During this time interval, the same condition as in the time interval 3D according to the exemplary embodiment 1 is obtained.

[Time Interval 12B]

During this time interval, the buffering quantity (ii) is moderately elevated, and the medium access throughput (iv) largely drops. Therefore, the throughput variation (downward) equals or exceeds its threshold value though the buffering quantity variation (upward) stays below its threshold value. Having detected that the throughput variation (downward) is equal to or larger than its threshold value, the optimum buffer allocation estimation and decision device 212 outputs a first backup buffer allocation signal (increase) to the backup buffer management device 213. The backup buffer management device 213, which received the first backup buffer allocation signal (increase), allocates a first backup buffer having a first capacity to the data buffer 203 for medium data write. As a result, the maximum buffering capacity (v) in the data buffer 203 for medium data write is increased by the additional capacity of the first backup buffer. The first backup buffer is actually allocated to the data buffer 203 for medium data write in an initial stage of the next time interval 12C.

[Time Interval 12C]

During this time interval, the medium access throughput shows a largest drop and then an upward turn (improvement), however the throughput variation (upward) stays below its threshold value. On the other hand, the buffering quantity (upward) equals or exceeds its threshold value. The optimum buffer allocation estimation and decision device 212, which detected that the buffering quantity (upward) is equal to or larger than its threshold value, outputs a second backup buffer allocation signal (increase) to the backup buffer management device 213. The backup buffer management device 213, which received the second backup buffer allocation signal (increase), allocates a second backup buffer having a second capacity in place of the first backup buffer to the data buffer 203 for medium data write. The second capacity is larger than the first capacity (second capacity>first capacity), and the data buffer 203 further increases its maximum buffering capacity (v). The second backup buffer is actually allocated to the data buffer 203 for medium data write in an initial stage of the next time interval 12D.

During the time interval 12C, the capacity increase larger than that of the time interval 9B is provided for the data buffer 203 for medium data write. Such a capacity increase allows the data buffer 203 to well receive the increasing buffering quantity (ii).

[Time Interval 12D, Time Interval 12E]

During this time interval, the maximum capacity of a buffering quantity (iii) increases as compared to the time interval 12C, which enables a more flexible buffer control suitable for the apparatus condition than in the exemplary embodiment 3. Therefore, the buffering quantity (ii) may increase beyond the conventional maximum buffering capacity (v) in a terminal stage of the time interval 12D and the time interval 12E, however, the risk of system breakdown can be more reliably avoided because the buffer maximum quantity (v) is set to be larger than a peak value of the increased buffering quantity (ii) with a high accuracy.

During the time interval 12D, the buffering quantity continues to rise, and the buffering quantity variation (upward) stays equal to or exceeds its threshold value. The downward medium access throughput shows an upward turn, however, the throughput variation (upward) is still below its threshold value. The optimum buffer allocation estimation and decision device 212 which detected the condition continues to output the second backup buffer allocation signal (increase), and the backup buffer having the larger capacity continues to be allocated (allocation of the second capacity) to the data buffer 203 for medium data write.

During the time interval 12E, the upward buffering quantity which shows a downward turn, however, the buffering quantity variation (downward) stays below its threshold value. The medium access throughput continues to rise, and the throughput variation (upward) equals or exceeds its threshold value. The optimum buffer allocation estimation and decision device 212 which detected the condition outputs the first backup buffer allocation signal (decrease). The backup buffer management device 213 receives the outputted first backup buffer allocation signal (decrease), and correspondingly changes the backup buffer to be allocated to the data buffer 203 for medium data write from the second backup buffer (having the second capacity) to the first backup buffer (having the first capacity). Because the first capacity<the second capacity, the maximum buffering capacity (v) in the data buffer 203 for medium data write slightly reduces. The backup buffer to be allocated is actually changed from the second backup buffer to the first backup buffer in an initial stage of the next time interval 12F.

[Time Interval 12F]

During this time interval, the buffering quantity continues to fall, and the buffering quantity variation (downward) stays equal to or exceeds its threshold value. The medium access throughput continues to rise, and the throughput variation (upward) reaches or exceeds its threshold value during this time interval. The optimum buffer allocation estimation and decision device 212 which detected the condition outputs the second backup buffer allocation signal (decrease) in place of the first backup buffer allocation signal (decrease) to the backup buffer management device 213. The backup buffer management device 213 receives the second backup buffer allocation signal (decrease), and correspondingly discontinues the allocation of the first backup buffer (having the first capacity) to the data buffer 203 for medium data write. Accordingly, the maximum buffering capacity (v) in the data buffer 203 for medium data write is again the original maximum capacity of the buffer 203 per se. The first backup buffer is actually detached from the data buffer 203 for medium data write in an initial stage of the next time interval 12G.

[Time Interval 12G]

During this time interval, any backup buffer allocated to the data buffer 203 for medium data write is detached therefrom, so that the capacity (v) of the data buffer 203 for medium data write can stay at an optimum level.

As described so far, the present exemplary embodiment adjusts the maximum buffering capacity by determining whether the throughput variation and the buffering quantity variation are overly elevated. In the case where the writing speed temporarily slows down owing to some trouble occurring in the recording medium, therefore, the number of rotations of the CD drive apparatus 100 can be constantly sustained when the audio data is ripped.

In the description of the exemplary embodiment 4 given so far, the optimum buffer allocation estimation and decision device 212 generates the backup buffer allocation signal based on the following first-third parameters, and outputs the generated the backup buffer allocation signal to the backup buffer management device 213;
first parameter: throughput variation (volume of dataflow per unit to the data recording device 204,
second parameter: buffering quantity variation in the data buffer 201 for CD signal input (buffering quantity variation per unit time), and
third parameter: buffering quantity variation in the data buffer 203 for medium data write (buffering quantity variation per unit time).

The rotation control signal may be generated, for example, as defined below;
the backup buffer allocation signal is generated based on the second parameter alone,
the backup buffer allocation signal is generated based on the second and third parameters,
the backup buffer allocation signal is generated based on the third parameter alone,
the backup buffer allocation signal is generated based on the first and second parameters, or
the backup buffer allocation signal is generated based on the first and third parameters.

### Exemplary Embodiment 5

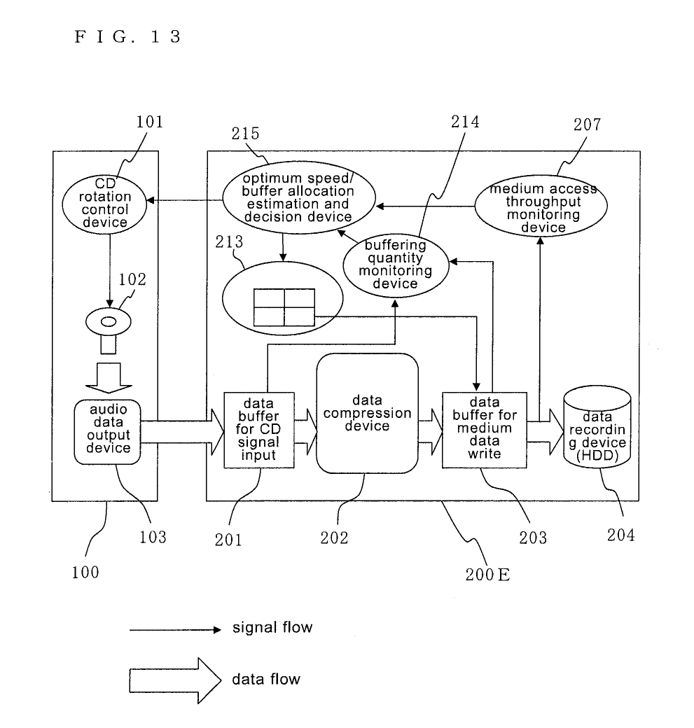

A recording and reproduction apparatus according to an exemplary embodiment 5 of the present invention is described referring to FIGS. 13-15. FIG. 13 is a block diagram illustrating a structure of a CD ripping apparatus 200E which is the recording and reproduction apparatus according to the present exemplary embodiment. The description given below does not refer to devices illustrated in FIG. 13 structurally similar to those described in the exemplary embodiments 1 and 4, which are a CD drive apparatus 100, a data buffer 201 for CD signal input, a data compression device 202, a data buffer 203 for medium data write, a data recording device 204, a medium access throughput monitoring device 207, a backup buffer management device 213, and a buffering quantity monitoring device 214.

The ripping apparatus 200E is provided with an optimum speed/buffer allocation estimation and decision device 215. The optimum speed/buffer allocation estimation and decision device 215 records therein the throughput monitor signal supplied from the medium access throughput monitoring device 207 and the buffering quantity monitor signal supplied from the buffering quantity monitoring device 214 per unit time. The optimum speed/buffer allocation estimation and decision device 215 analyzes changes of the throughput monitor signals each recorded per unit time and changes of the buffering quantity monitor signals each recorded per unit time to monitor the throughput variation and the buffering quantity variation. Then, the optimum speed/buffer allocation estimation and decision device 215 controls the output speed of the digital audio data and the allocation of the backup buffer based on a monitoring result thus obtained as described below.

Having detected that the throughput variation (downward) or the buffering quantity variation (upward) is equal to or larger than its threshold value, the optimum speed/buffer allocation estimation and decision device 215 determines a considerable drop in the throughput of any block, based on which the optimum speed/buffer allocation estimation and decision device 215 gives the estimation that “there is a high likelihood of future overflow in the data buffer 201, 203”.

Based on the estimation, the optimum speed/buffer allocation estimation and decision device 215 outputs the rotation control signal (lower number of rotations) to the CD rotation control device 101, and outputs the backup buffer allocation signal (increase) to the backup buffer management device 213.

In response to the supply of the rotation control signal (lower number of rotations) from the optimum speed/buffer allocation estimation and decision device 215, the CD rotation control device 101 outputs the rotation control signal (lower number of rotations) to the CD reproduction device 102 to thereby perform the rotation control (lower number of rotations) of the CD reproduction device 102. As a result, the output speed of the CD data outputted to the ripping apparatus 200E slows down. The backup buffer management device 213 allocates the backup buffer managed by the backup buffer management device 213 to the data buffer 203 for medium data write based on the backup buffer allocation signal (increase) supplied from the optimum speed/buffer allocation estimation and decision device 215.

The backup buffer management device 211 allocates the backup buffer managed by the backup buffer management device 213 to the data buffer 203 for medium data write based on the backup buffer allocation signal (increase) supplied from the optimum speed/buffer allocation estimation and decision device 215.

Different systems have different optimum values for the buffering quantity variations in the data buffers, and the rate of rotation control for the CD drive apparatus 100. When the rotation of the CD drive apparatus 100 and the buffering quantity variations are both controlled, a broader range of system setting is available, and any risks involved in the system can be alleviated.

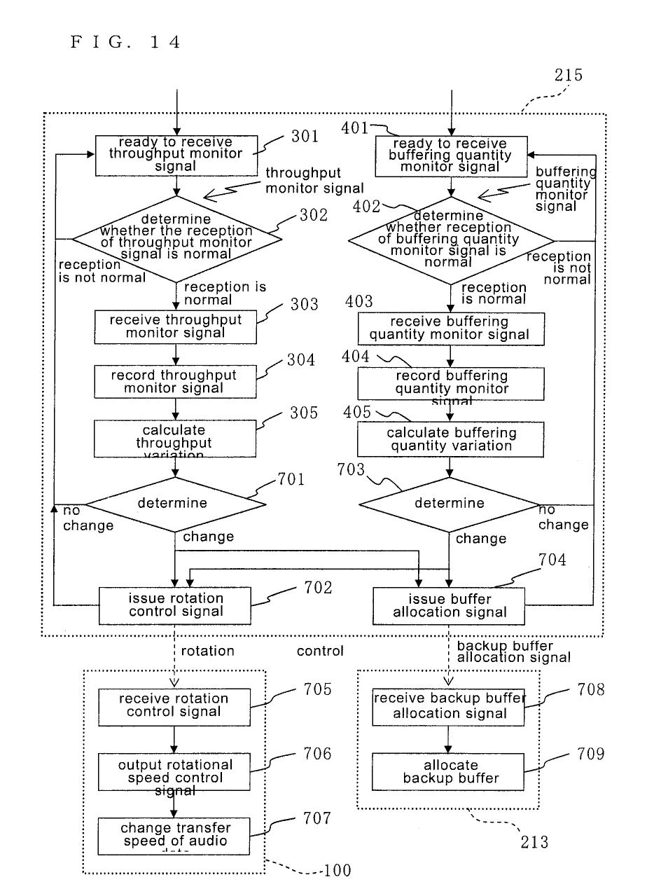

FIG. 14 is a flow chart illustrating processing steps carried out by the optimum speed/buffer allocation estimation and decision device 215, CD drive apparatus 100, and backup buffer management device 213. Steps 301-305, and 401-405 are similar to the processing steps described in the exemplary embodiments 1 and 2, and will not be described below.

When the optimum speed/buffer allocation estimation and decision device 215 determines in Step 701 that the throughput variation (calculated in Step 305) is smaller than its threshold value, the optimum speed/buffer allocation estimation and decision device 215 returns to Step 301. Having determined in Step 701 that the throughput variation is equal to or larger than its threshold value, the optimum speed/buffer allocation estimation and decision device 215 outputs in Step 702 the rotation control signal to the CD rotation control device 101, and further outputs in Step 704 the backup buffer allocation signal to the backup buffer management device 213. Then, the optimum speed/buffer allocation estimation and decision device 215 returns to Step 301 to be ready to receive the throughput monitor signal.

When the optimum speed/buffer allocation estimation and decision device 215 determines in Step 703 that the buffering quantity variation (calculated in Step 405) is smaller than its threshold value, the optimum speed/buffer allocation estimation and decision device 215 returns to Step 401. Having determined in Step 703 that the buffering quantity variation is equal to or larger than is threshold value, the optimum speed/buffer allocation estimation and decision device 215 outputs in Step 702 the rotation control signal to the CD rotation control device 101, and further outputs in Step 704 the backup buffer allocation signal to the backup buffer management device 213. Then, the optimum speed/buffer allocation estimation and decision device 215 returns to Step 401 to be ready to receive the buffering quantity monitor signal.

The rotation control signal outputted in Step 704 by the optimum speed/buffer allocation estimation and decision device 215 is received in Step 705 by the CD rotation control device 101. The CD rotation control device 101 receives the rotation control signal, and correspondingly outputs in Step 706 the rotational speed control signal to the CD reproduction device 102. The CD reproduction device 102 controls the rotational speed for CD reproduction in Step 707 based on the supplied rotational speed control signal. As a result of the rotational speed control, the output signal speed of the audio data from the CD drive apparatus 100 to the ripping apparatus 200E is controlled. The rotation is controlled in two different manners; the CD reproduction speed by the CD reproduction device 102 is decreased (deceleration), and the CD reproduction speed by the CD reproduction device 102 is increased (acceleration).

The backup buffer allocation signal outputted in Step 704 by the optimum speed/buffer allocation estimation and decision device 215 is received in Step 708 by the backup buffer management device 213. When the backup buffer management device 23 receives the backup buffer allocation signal, the backup buffer management device 23 adjusts in Step 709 the backup buffering quantity of the data buffer 203 for medium data write. The adjustment includes allocation of the backup buffer from the backup buffer management device 213 to the data buffer 203 for medium data write, and returning the backup buffer allocated to the data buffer 203 for medium data write to the backup buffer management device 213.

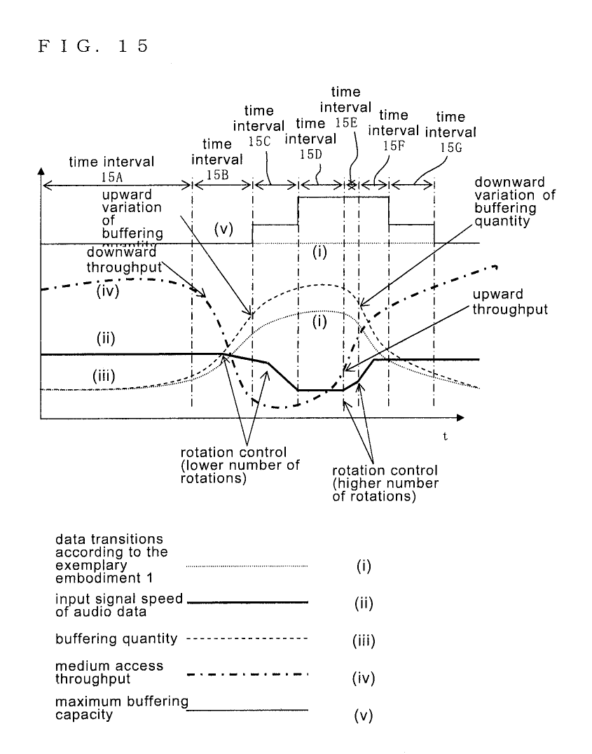

FIG. 15 is a diagram illustrating transitions of the input signal speed of audio data, buffering quantity, and medium access throughput according to the present exemplary embodiment.

[Time Interval 15A]

During this time interval, the same condition as in the time interval 3D according to the exemplary embodiment 1 is obtained.

### [Time Interval 15B]

During this time interval, the buffering quantity is moderately elevated, however, the buffering quantity variation (upward) stays below its threshold value. The medium access throughput rapidly drops, and the throughput variation (downward) equals or exceeds its threshold value. The optimum speed/buffer allocation estimation and decision device 215 which detected the condition outputs the first rotation control signal (lower number of rotations) to the backup buffer management device 213, and also outputs the first backup buffer allocation signal (increase) to the backup buffer management device 213. During this time interval, the buffering quantity is on the slow and steady increase, however, the buffering quantity variation (upward) stays below its threshold value.

The CD rotation control device 101 performs the first rotation control (lower number of rotations) based on the first rotation control signal (lower number of rotations), and the audio data input signal speed (ii) starts to fall. The backup buffer management device 213 receives the first backup buffer allocation signal (increase), and correspondingly allocates the first backup buffer having the first capacity to the data buffer 203 for medium data write. As a result of the allocation, the maximum buffering capacity (v) in the data buffer 203 for medium data write increases by the capacity of the first backup buffer. The first backup buffer is actually allocated to the data buffer 203 for medium data write in an initial stage of the next time interval 15C.

[Time Interval 15C]

During this time interval, the medium access throughput is stabilized near its lowest value, and the throughput variation (downward) is as close to zero as possible. The buffering quantity, on the other hand, is rapidly elevated, and the buffering quantity variation (upward) equals or exceeds its threshold value. The optimum speed/buffer allocation estimation and decision device 215 which detected the condition outputs the second backup buffer allocation signal (increase) to the backup buffer management device 213 and the second rotation control signal (lower number of rotations) to the CD drive apparatus 100.

The CD rotation control device 101 performs the second rotation control (lower number of rotations) based on the second rotation control signal (lower number of rotations). The rotational speed is controlled so that a rate of change of the rotational speed generated by the send rotation control (lower number of rotations) is larger than a rate of change of the rotational speed generated by the first rotation control (lower number of rotations). As a result, the audio data input signal speed (ii) more rapidly drops than in the time interval 12B. The rotational speed control thus technically characterized is not performed in the exemplary embodiment 1. In the present exemplary embodiment thus controlling the rotational speed, the buffering quantity does not increase as much as in the exemplary embodiment 1.

The backup buffer management device 213 which received the second backup buffer allocation signal (increase) allocates the second backup buffer having the second capacity to the data buffer 203 for medium data write in place of the first backup buffer. The second capacity is larger than the first capacity (second capacity>first capacity). As a result, the maximum buffering capacity (v) in the data buffer 203 further increases. The second backup buffer is actually allocated to the data buffer 203 for medium data write in an initial stage of the next time interval 15D.

The rotational speed control according to the present exemplary embodiment lessens a rate of decrease in the rotational speed as compared to the exemplary embodiment 1, thereby allowing a large increase in the buffering quantity (iii) in contrast to the exemplary embodiment 1. According to the present exemplary embodiment, however, there is still an expected buffering space because the maximum buffering capacity (v) increases while accurately following the changes of the buffering quantity (iii).

[Time Interval 15D]

During this time interval, the throughput shows an upward turn, however, the throughput variation (upward) is not yet equal to or larger than its threshold value, and the buffering quantity variation (upward) is also smaller than its threshold value. The optimum speed/buffer allocation estimation and decision device 215 which detected the condition continues to output the second backup buffer allocation signal (increase), however discontinues the output of the second rotation control signal (lower number of rotations). Accordingly, the allocation of the backup buffer having the larger capacity (allocation of the second capacity) to the data buffer 203 for medium data write is sustained. The CD rotation control device 101 discontinues the second rotation control (lower number of rotations) and sustains the rotational speed at the time. Therefore, the rotational speed of the CD drive apparatus stays at a lower speed than in the time interval 3F according to the exemplary embodiment 1, and the audio data input signal speed (ii) stays at a constant speed.

[Time Interval 15E]

During this time interval, the buffering quantity shows a downward turn, however, the buffering quantity variation (downward) is not yet equal to or larger than its threshold value. The throughput shows an upward turn, and the throughput variation (upward) equals or exceeds its threshold value. The optimum speed/buffer allocation estimation and decision device 215 which detected the condition continues to output the second backup buffer allocation signal (increase), while outputting the first rotation control signal (higher number of rotations) to the CD reproduction device 102 to perform the first rotation control (higher number of rotations), so that the audio data input single speed (ii) is elevated.

[Time Interval 15D]

During this time interval, the throughput variation (upward) stays equal to or exceeds its threshold value, and the buffering quantity variation (downward) is equal to or larger than its threshold value. The optimum speed/buffer allocation estimation and decision device 215 which detected the condition carries out the following two different signal changes. In a first signal change, the optimum speed/buffer allocation estimation and decision device 215 changes the signal to be outputted to the backup buffer management device 213 from the second backup buffer allocation signal (increase) to the first backup buffer allocation signal (decrease), and outputs the first backup buffer allocation signal (decrease) to the backup buffer management device 213. The backup buffer management device 213 receives the first backup buffer allocation signal (decrease), and changes the backup buffer to be allocated to the data buffer 203 for medium data write from the second backup buffer (having the second capacity) to the first backup buffer (having the first capacity). Because the first capacity<the second capacity, the maximum buffering capacity (v) in the data buffer for medium data write slightly decreases. The backup buffer to be allocated is actually changed from the second backup buffer to the first backup buffer in an initial stage of the next time interval 15G.

In a second signal change, the optimum speed/buffer allocation estimation and decision device 215 changes the signal to be outputted to the CD reproduction device 102 from the first rotation control signal (higher number of rotations) to the second rotation control signal (higher number of rotations), and outputs the second rotation control signal (higher number of rotations) to the CD reproduction device 102. The CD reproduction device 102 receives the second rotation control signal (higher number of rotations), and performs the second rotation control (higher number of rotations) to raise the audio data input signal speed (ii). The rotation is controlled so that a rate of change of the rotation by the second rotation control (higher number of rotations) is larger than a rate of change of the rotation by the first rotation control (higher number of rotations). Therefore, the audio data input signal speed (ii) increases more rapidly than in the time interval 15E. The audio data input signal speed (ii), after reaching the speed in the time interval 15A, no longer increases but stays at the speed then.

[Time Interval 15G]

During this time interval, the throughput variation (upward) and the buffering quantity variation (downward) are both smaller than their threshold values. The optimum speed/buffer allocation estimation and decision device 215 which detected the condition changes the signal to be outputted to the backup buffer management device 213 from the first backup buffer allocation signal (decrease) to the second backup buffer allocation signal (decrease), and outputs the second backup buffer allocation signal (decrease) to the backup buffer management device 213. The backup buffer management device 213 receives the second backup buffer allocation signal (decrease), and discontinues the allocation of the first backup buffer (having the first capacity) to the data buffer 203 for medium data write. Accordingly, the maximum buffering capacity (v) in the data buffer 203 for medium data write is again the original maximum capacity of the buffer 203 per se. The first backup buffer is actually detached from the data buffer 203 for medium data write when the next time interval 15G is over. In the second rotation control (higher number of rotations), the number of rotations for reproduction to be increased in the CD reproduction device 102 is controlled not to exceed the number of rotations for reproduction in the time interval 15A. When the number of rotations for reproduction reaches the number of rotations for reproduction in the time interval 15A, the rotation control stops, and the number of rotations for reproduction at the time is sustained. The decision to suspend the rotation control is concurrent with the decision to suspend the second rotation control (higher number of rotations) based on the comparison of the throughput variation (upward) and the buffering quantity variation (downward) to their threshold values. The second rotation control (higher number of rotations) is suspended based on one of the decision results.

The present exemplary embodiment combines the rotation control of the CD drive apparatus 100 and the up-down control of the maximum buffering capacity to thereby reduce the control threshold values and the control rate. The following operational effects can be accordingly obtained;
the range of reduction in the number of rotations can be smaller,
any impact on the overall ripping time can be lessened
the capacity of the backup buffer can be reduced, and
these three advantages lead to the reduction of the total memory capacity in the whole system.

As described so far, the present exemplary embodiment adjusts the audio data input signal speed based on the detected throughput variation and buffering quantity variation. Therefore, the CD drive control apparatus 100 can be more suitably controlled such that meets the current condition of the ripping apparatus 200E, and the audio data can be ripped at an optimal speed.

In the description of the exemplary embodiment 5 given so far, the optimum speed/buffer allocation estimation and decision device 215 generates the rotation control signal and the backup buffer allocation signal based on the following first-third parameters, and outputs the generated signals to the CD rotation control device 101 and the backup buffer management device 213;
first parameter: throughput variation (volume of dataflow per unit to the data recording device 204,
second parameter: buffering quantity variation in the data buffer 201 for CD signal input (buffering quantity variation per unit time), and
third parameter: buffering quantity variation in the data buffer 203 for medium data write (buffering quantity variation per unit time).

The rotation control signal may be generated, for example, as defined below;
the rotation control signal is generated based on the second parameter alone,
the rotation control signal is generated based on the second and third parameters,
the rotation control signal is generated based on the third parameter alone,
the rotation control signal is generated based on the first and second parameters, or
the rotation control signal is generated based on the first and third parameters.

### Exemplary Embodiment 6

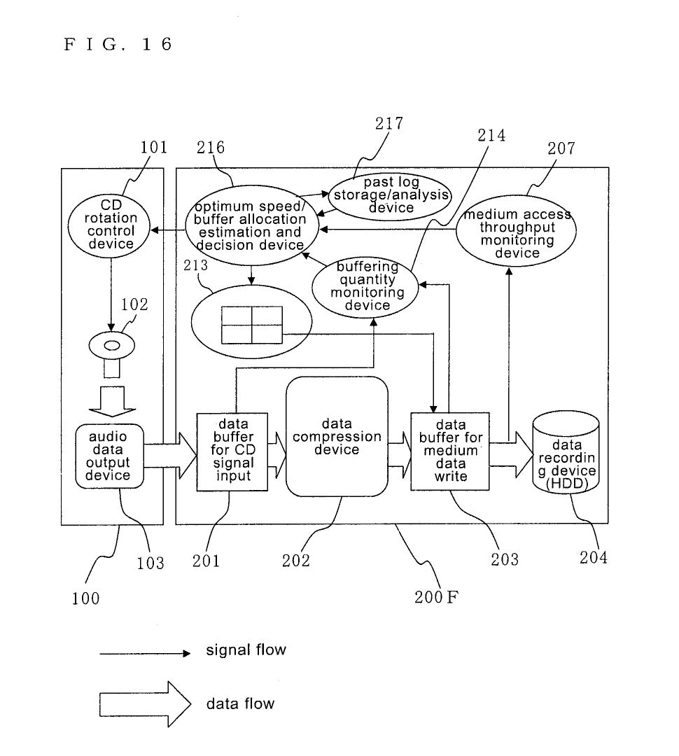

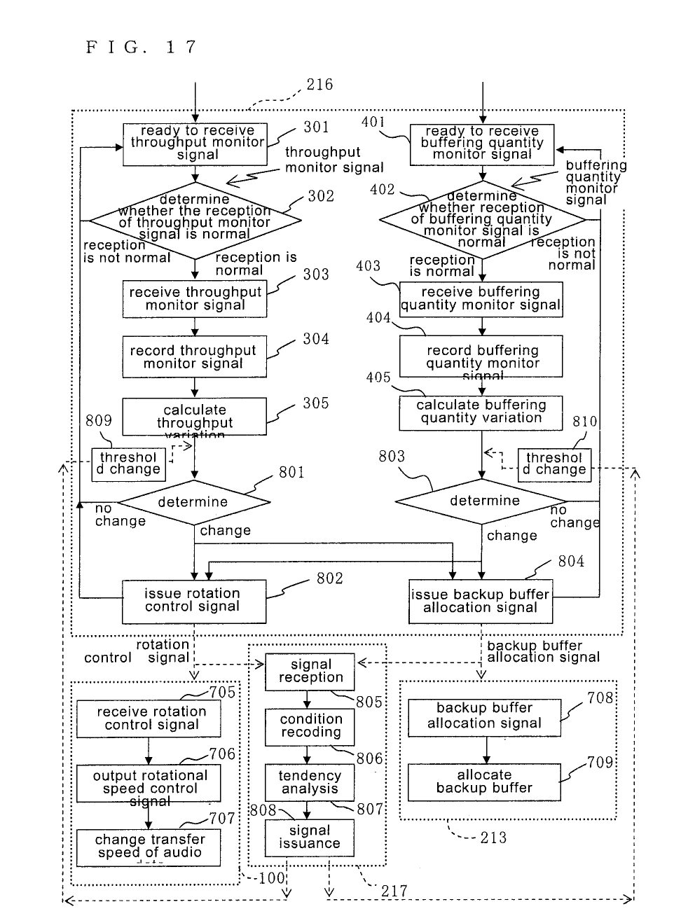

A recording and reproduction apparatus according to an exemplary embodiment 6 of the present invention is described referring to FIGS. 16 and 17. FIG. 16 is a block diagram illustrating a structure of a CD ripping apparatus 200F which is the recording and reproduction apparatus according to the present exemplary embodiment. The description given below does not refer to devices illustrated in FIG. 16 structurally similar to those described in the exemplary embodiments 1 and 4, which are a CD drive apparatus 100, a data buffer 201 for CD signal input, a data compression device 202, a data buffer 203 for medium data write, a data recording device 204, a medium access throughput monitoring device 207, a backup buffer management device 213, and a buffering quantity monitoring device 214.

The ripping apparatus 200F is provided with an optimum speed/buffer allocation estimation and decision device 216 and a past log storage/analysis device 217. Similarly to the exemplary embodiment 5, the optimum speed/buffer allocation estimation and decision device 216 outputs the rotation control signal to the CD rotation control device 101 and outputs the backup buffer allocation signal to the backup buffer management device 213. The optimum speed/buffer allocation estimation and decision device 216 further outputs the rotation control signal and the backup buffer allocation signal to the past log storage/analysis device 217.

The past log storage/analysis device 217 records therein changes of the rotation control signal and the backup buffer allocation signal, and performs a tendency analysis on, for example, changes in the rotation of the CD drive apparatus 100 and a remaining buffering quantity. Based on an analysis result thereby obtained, the past log storage/analysis device 217 determines whether the threshold values respectively predefined for the rotation control signal and the backup buffer allocation signal should be changed. When the past log storage/analysis device 217 determines it is necessary to change these threshold values, the past log storage/analysis device 217 outputs threshold change signals to the optimum speed/buffer allocation estimation and decision device 216. The optimum speed/buffer allocation estimation and decision device 216 which received these signals changes the respective threshold values, and carries out the processing steps thereafter based on the changed threshold values.

FIG. 17 is a flow chart illustrating processing steps carried out by the optimum speed/buffer allocation estimation and decision device 216, CD drive apparatus 100, backup buffer management device 213, and past log storage/analysis device 217. Steps 301-305, 401-405, and 705-709 are similar to the processing steps described in the exemplary embodiments 1, 2 and 5, and will not be described below.

When the optimum speed/buffer allocation estimation and decision device 216 determines in Step 801 that the throughput variation (calculated in Step 305) is smaller than its threshold value, the optimum speed/buffer allocation estimation and decision device 216 returns to Step 301. When the optimum speed/buffer allocation estimation and decision device 216 determines in Step 801 that the throughput variation is equal to or larger than its threshold value, the optimum speed/buffer allocation estimation and decision device 216 outputs in Step 802 the rotation control signal to the CD rotation control device 101, and also outputs in Step 804 the backup buffer allocation signal to the backup buffer management device 213. Then, the optimum speed/buffer allocation estimation and decision device 216 returns to Step 301 to be ready to receive the throughput monitor signal.

When the optimum speed/buffer allocation estimation and decision device 216 determines in Step 803 that the buffering quantity variation (calculated in Step 405) is smaller than its threshold value, the optimum speed/buffer allocation estimation and decision device 216 returns to Step 401. When the optimum speed/buffer allocation estimation and decision device 216 determines in Step 803 that the buffering quantity variation is equal to or larger than its threshold value, the optimum speed/buffer allocation estimation and decision device 216 outputs in Step 802 the rotation control signal to the CD rotation control device 101, and also outputs in Step 804 the backup buffer allocation signal to the backup buffer management device 213. Then, the optimum speed/buffer allocation estimation and decision device 216 returns to Step 401 to be ready to receive the throughput monitor signal.

The rotation control signal outputted in Step 804 by the optimum speed/buffer allocation estimation and decision device 216 is received in Step 705 by the CD rotation control device 101. When the CD rotation control device 101 receives the rotation control signal, the CD rotation control device 101 outputs in Step 706 the rotational speed control signal to the CD reproduction device 102. In Step 707, the CD reproduction device 102 controls the rotational speed for CD reproduction based on the supplied rotational speed control signal. Accordingly, the output signal speed of the audio data supplied from the CD drive apparatus 100 to the ripping apparatus 200E is controlled. There are two different manners of controlling the CD production speed, which are decrease (deceleration) and increase (acceleration).

The backup buffer allocation signal outputted in Step 704 by the optimum speed/buffer allocation estimation and decision device 216 is received in Step 708 by the backup buffer management device 213. When the backup buffer management device 213 receives the backup buffer allocation signal, the backup buffer management device 213 adjusts in Step 709 a remaining backup buffering quantity in the data buffer 203 for medium data write. There are two different manners of adjusting the buffering quantity, which are adjustment by allocating the backup buffer to the data buffer 203 for medium data write from the backup buffer management device 213, and adjustment by returning the backup buffer from data buffer 203 for medium data write to the backup buffer management device 213. In the description of the present exemplary embodiment, these two adjustments are collectively called allocation.

The rotation control signal and the backup buffer allocation signal outputted in Steps 802 and 804 are transferred to the past log storage/analysis device 217 at the same time. The transferred rotation control signal and backup buffer allocation signal are received in Step in 805 by the past log storage/analysis device 217, and further recorded in Step 806 in the past log storage/analysis device 217. These signals thus recorded are stored in the past log storage/analysis device 217 over a given period of time. In Step 807, the past log storage/analysis device 217 analyzes the tendency of the rotation control in the CD rotation control device 101 and the tendency of the buffering quantity control in the backup buffer management device 213 based on signal data stored therein. In Step 808, the past log storage/analysis device 217 outputs a threshold change command signal (rotation) and a threshold change command signal (allocation) to the optimum speed/buffer allocation estimation and decision device 216 based on an analysis result (tendency) obtained in Step 807. In Step 809, the optimum speed/buffer allocation estimation and decision device 216 changes the threshold value used in Step 801 based on the supplied threshold change command signal (rotation). Further, in Step 810, the optimum speed/buffer allocation estimation and decision device 216 changes the threshold value used in Step 803 based on the supplied threshold change command signal (allocation).

When, for example, there is a tendency that the backup buffer allocation signal is more frequently outputted, the past log storage/analysis device 217 determines “it is likely that the capacity of the backup buffer is exhausted”. In order to avoid the risk of capacity exhaustion, the past log storage/analysis device 217 generates the threshold change command signal (rotation) which reduces the threshold value used when the rotation control signal is issued, and outputs the generated threshold change command signal to the optimum speed/buffer allocation estimation and decision device 216. As a result, the rotation control signal is more frequency generated, and the output of the backup buffer allocation signal is suspended. When there is a tendency that the rotation control signal is more frequently outputted, the past log storage/analysis device 217 determines “the overall ripping speed is slowing down”. Then, the past log storage/analysis device 217 generates the threshold change command signal which increases the threshold value in the rotation control signal and the threshold change command signal which decreases the threshold value in the backup buffer allocation signal, and outputs the generated command signals to the optimum speed/buffer allocation estimation and decision device 216. Thus controlled within the range of the backup buffer, the ripping speed is prevented from slowing down.

As described so far, the threshold values used to determine whether the rotation control signal and the backup buffer allocation signal are outputted are adjusted to optimum values when the apparatus is shipped. However, the threshold values set before the shipment may no longer be optimum values due to individual differences and variability over time. The present exemplary embodiment can deal with such a risk, and enables the mechanisms described in the exemplary embodiments 1-5 to optimally function.

In the description of the exemplary embodiment 4 given so far, the optimum speed estimation and decision device 216 generates the rotation control signal and the backup buffer allocation signal based on the following first-third parameters, and outputs the generated rotation control signal and the backup buffer allocation signal to the CD rotation control device 101 and the backup buffer management device 213;
first parameter: throughput variation (volume of dataflow per unit to the data recording device 204,
second parameter: buffering quantity variation in the data buffer 201 for CD signal input (buffering quantity variation per unit time), and
third parameter: buffering quantity variation in the data buffer 203 for medium data write (buffering quantity variation per unit time).

The rotation control signal may be generated, for example, as defined below;
the rotation control signal is generated based on the second parameter alone,
the rotation control signal is generated based on the second and third parameters,
the rotation control signal is generated based on the third parameter alone,
the rotation control signal is generated based on the first and second parameters, or
the rotation control signal is generated based on the first and third parameters.

When the processed data are jointly used as described in the exemplary embodiments 1, 3 and 6, the processing steps can be more efficiently carried out.

### INDUSTRIAL APPLICABILITY

A recording and reproduction apparatus according to the present invention is capable of making different decisions in dependence upon on circumferential conditions and applicable to, for example, a digital audio high-speed processing system. The recording and reproduction apparatus according to the present invention is not necessarily limited to the audio system, and is also applicable to, for example, a video recording and reproduction apparatus which processes data streams.

### DESCRIPTION OF REFERENCE SYMBOLS

100 CD drive apparatus
101 CD rotation control device
102 CD reproduction device
103 audio data output device
200A-200F ripping apparatus
201 data buffer for CD signal input (first buffer)
202 data compression device
203 data buffer for medium data write (second buffer)
204 data recording device
206, 208 optimum speed estimation and decision device
207 medium access throughput monitoring device
209, 214 buffering quantity monitoring device
210, 212 optimum buffer allocation estimation and decision device
211, 213 backup buffer management device
215, 216 optimum speed/buffer allocation estimation and decision device
217 past log storage/analysis device

1. A recording and reproduction device comprising:
a buffer for storing therein data reproduced by a CD drive apparatus capable of adjusting a data reproduction volume which is a volume of data to be reproduced per unit time;
a recording unit for recording therein the data read from the buffer; and
a decision unit for generating a signal which adjusts the data reproduction volume based on a change generated in a buffering quantity in the buffer or a change generated in a volume of data flow in the recording unit to output the generated signal to the CD drive apparatus.

2. The recording and reproduction device as claimed in claim 1, wherein
the decision unit generates a signal which adjusts the data reproduction volume based on a medium access throughput indicating a volume of the data supplied to the recording unit per unit time.

3. The recording and reproduction device as claimed in claim 2, further comprising a throughput monitoring unit for measuring an amount of time required for completion of data write per unit time to write the data in the recording unit every time when the data is written per the unit time in the recording unit to output the measured amount of time required for completion of data write to the decision unit, wherein
the decision unit measures the medium access throughput based on the amount of time required for completion of data write.

4. The recording and reproduction device as claimed in claim 3, wherein
the decision unit generates a signal which adjusts the data reproduction volume based on a variation of the medium access throughput.

5. The recording and reproduction device as claimed in claim 1, further comprising a compression unit, the buffer including a first buffer and a second buffer, wherein
the first buffer stores therein data reproduced by the CD drive apparatus,
the compression unit reads the data stored in the first buffer therefrom and compresses the read data,
the second buffer stores therein the data compressed by the compression unit, and
the recording unit reads the compressed data from the second buffer and records therein the read data.

6. The recording and reproduction device as claimed in claim 4, wherein
the decision unit generates a signal which adjusts the data reproduction volume based on a variation of the buffering quantity per unit time in the first buffer.

7. The recording and reproduction device as claimed in claim 4, wherein
the decision unit generates a signal which adjusts the data reproduction volume based on a variation of the buffering quantity per unit time in the first buffer and a variation of the buffering quantity per unit time in the second buffer.

8. The recording and reproduction device as claimed in claim 4, wherein
the decision unit generates a signal which adjusts the data reproduction volume based on a variation of the buffering quantity per unit time in the second buffer.

9. The recording and reproduction device as claimed in claim 4, wherein
the decision unit generates a signal which adjusts the data reproduction volume based on a variation of the buffering quantity per unit time in the first buffer and the variation of the medium access throughput indicating the volume of the data supplied to the recording unit per unit time.

10. The recording and reproduction device as claimed in claim 4, wherein
the decision unit generates a signal which adjusts the data reproduction volume based on the variation of the medium access throughput indicating the volume of the data supplied to the recording unit per unit time, a variation of the buffering quantity per unit time in the first buffer, and a variation of the buffering quantity per unit time in the second buffer.

11. The recording and reproduction device as claimed in claim 4, wherein
the decision unit generates a signal which adjusts the data reproduction volume based on the variation of the medium access throughput indicating the volume of the data supplied to the recording unit per unit time and a variation of the buffering quantity per unit time in the second buffer.

12. The recording and reproduction device as claimed in claim 6, further comprising a buffering quantity monitoring unit for measuring the buffering quantity variation per unit time based on a buffering quantity difference per unit time in the first buffer, the buffering quantity monitoring unit further outputting the buffering quantity variation thus measured to the decision unit.

13. The recording and reproduction device as claimed in claim 7, further comprising a buffering quantity monitoring unit for measuring the buffering quantity variation per unit time in the first buffer based on a buffering quantity difference per unit time in the first buffer, and further measuring the buffering quantity variation per unit time in the second buffer based on a buffering quantity difference per unit time in the second buffer, the buffering quantity monitoring unit further outputting the buffering quantity variations thus measured to the decision unit.

14. The recording and reproduction device as claimed in claim 8, further comprising a buffering quantity monitoring unit for measuring the buffering quantity variation per unit time in the second buffer based on a buffering quantity difference per unit time in the second buffer, the buffering quantity monitoring unit further outputting the buffering quantity variation thus measured to the decision unit.

15. A recording and reproduction device comprising:
a buffer for storing therein data reproduced by a CD drive apparatus;
a recording unit for recording therein the data read from the buffer;
a backup buffer management unit having a backup buffer to be allocated to the buffer and managing the allocation of the backup buffer; and
a decision unit for generating a signal which adjusts a buffering quantity of the backup buffer to be allocated based on a change generated in a buffering quantity in the buffer or a change generated in a volume of data flow in the recording unit to output the generated signal to the backup buffer management unit.

16. The recording and reproduction device as claimed in claim 15, further comprising a compression unit, the buffer including a first buffer and a second buffer, wherein
the first buffer stores therein data reproduced by the CD drive apparatus,
the compression unit reads the data stored in the first buffer therefrom and compresses the read data,
the second buffer stores therein the data compressed by the compression unit,
the recording unit reads the compressed data from the second buffer and records therein the read data,
the backup buffer management unit manages the backup buffer to be allocated to the second buffer, and
the decision unit generates a signal which adjusts the buffering quantity of the backup buffer to be allocated based on a medium access throughput indicating a volume of the data supplied to the recording unit per unit time.

17. The recording and reproduction device as claimed in claim 16, further comprising a throughput monitoring unit for measuring an amount of time required for completion of data write per unit time to write the data in the recording unit every time when the data is written per the unit time in the recording unit to output the measured amount of time required for completion of data write to the decision unit, wherein
the decision unit measures the medium access throughput based on the amount of time for completion of data write.

18. The recording and reproduction device as claimed in claim 17, wherein
the decision unit generates a signal which adjusts the buffering quantity of the backup buffer to be allocated based on a variation of the medium access throughput.

19. The recording and reproduction device as claimed in claim 15, further comprising a compression unit, the buffer including a first buffer and a second buffer, wherein
the first buffer stores therein data reproduced by the CD drive apparatus,
the compression unit reads the data stored in the first buffer therefrom and compresses the read data,
the second buffer stores therein the data compressed by the compression unit,
the recording unit reads the compressed data from the second buffer and records therein the read data,
the backup buffer management unit manages the backup buffer to be allocated to the second buffer, and
the decision unit generates a signal which adjusts the buffering quantity of the backup buffer to be allocated based on a variation of the buffering quantity per unit time in the first buffer.

20. The recording and reproduction device as claimed in claim 15, further comprising a compression unit, the buffer including a first buffer and a second buffer, wherein
the first buffer stores therein data reproduced by the CD drive apparatus,
the compression unit reads the data stored in the first buffer therefrom and compresses the read data,
the second buffer stores therein the data compressed by the compression unit,
the recording unit reads the compressed data from the second buffer and records therein the read data, and
the decision unit generates a signal which adjusts the buffering quantity of the backup buffer to be allocated based on a variation of the buffering quantity per unit time in the first buffer and a variation of the buffering quantity per unit time in the second buffer.

21. The recording and reproduction device as claimed in claim 15, further comprising a compression unit, the buffer including a first buffer and a second buffer, wherein
the first buffer stores therein data reproduced by the CD drive apparatus,
the compression unit reads the data stored in the first buffer therefrom and compresses the read data,
the second buffer stores therein the data compressed by the compression unit,
the recording unit reads the compressed data from the second buffer and records therein the read data, and
the decision unit generates a signal which adjusts the buffering quantity of the backup buffer to be allocated based on a variation of the buffering quantity per unit time in the second buffer.

22. The recording and reproduction device as claimed in claim 19, wherein
the decision unit generates a signal which adjusts the buffering quantity of the backup buffer to be allocated based on a variation of the buffering quantity per unit time in the first buffer and a variation of a medium access throughput indicating a volume of the data supplied to the recording unit per unit time.

23. The recording and reproduction device as claimed in claim 20, wherein
the decision unit generates a signal which adjusts the buffering quantity of the backup buffer to be allocated based on a variation of a medium access throughput indicating a volume of the data supplied to the recording unit per unit time, the buffering quantity variation per unit time in the first buffer, and the buffering quantity variation per unit time in the second buffer.

24. The recording and reproduction device as claimed in claim 21, wherein
the decision unit generates a signal which adjusts the buffering quantity of the backup buffer to be allocated based on a variation of a medium access throughput indicating a volume of the data supplied to the recording unit per unit time and the buffering quantity variation per unit time in the second buffer.

25. The recording and reproduction device as claimed in claim 19, further comprising a buffering quantity monitoring unit for measuring the buffering quantity variation per unit time based on a buffering quantity difference per unit time in the first buffer, the buffering quantity monitoring unit further outputting the buffering quantity variation thus measured to the decision unit.

26. The recording and reproduction device as claimed in claim 20, further comprising a buffering quantity monitoring unit for measuring the buffering quantity variation per unit time in the first buffer based on a buffering quantity difference per unit time in the first buffer, and further measuring the buffering quantity variation per unit time in the second buffer based on a buffering quantity difference per unit time in the second buffer, the buffering quantity monitoring unit further outputting the buffering quantity variations thus measured to the decision unit.

27. The recording and reproduction device as claimed in claim 21, further comprising a buffering quantity monitoring unit for measuring the buffering quantity variation per unit time in the second buffer based on a buffering quantity difference per unit time in the second buffer, the buffering quantity monitoring unit further outputting the buffering quantity variation thus measured to the decision unit.

28. The recording and reproduction device as claimed in claim 15, wherein
the CD drive apparatus can adjust a data reproduction volume which is a volume of data to be reproduced per unit time, and
the decision unit generates a signal which adjusts the data reproduction volume based on a medium access throughput indicating a volume of the data supplied to the recording unit per unit time, and outputs the generated signal to the CD drive apparatus.

29. The recording and reproduction device as claimed in claim 15, further comprising a compression unit, the buffer including a first buffer and a second buffer, wherein
the first buffer stores therein data reproduced by the CD drive apparatus,
the compression unit reads the data stored in the first buffer therefrom and compresses the read data,
the second buffer stores therein the data compressed by the compression unit,
the recording unit reads the compressed data from the second buffer and records therein the read data,
the backup buffer management unit manages the backup buffer to be allocated to the second buffer,
the CD drive apparatus can adjust a data reproduction volume which is a volume of data to be reproduced per unit time, and
the decision unit generates a signal which adjusts the data reproduction volume based on a variation of the buffering quantity per unit time in the first buffer, and outputs the generated signal to the CD drive apparatus.

30. The recording and reproduction device as claimed in claim 15, further comprising a compression unit, the buffer including a first buffer and a second buffer, wherein
the first buffer stores therein data reproduced by the CD drive apparatus,
the compression unit reads the data stored in the first buffer therefrom and compresses the read data,
the second buffer stores therein the data compressed by the compression unit,
the recording unit reads the compressed data from the second buffer and records therein the read data,
the backup buffer management unit manages the backup buffer to be allocated to the second buffer,
the CD drive apparatus can adjust a data reproduction volume which is a volume of data to be reproduced per unit time, and
the decision unit generates a signal which adjusts the data reproduction volume based on a variation of the buffering quantity per unit time in the first buffer and a variation of the buffering quantity per unit time in the second buffer, and outputs the generated signal to the CD drive apparatus.

31. The recording and reproduction device as claimed in claim 15, further comprising a compression unit, the buffer including a first buffer and a second buffer, wherein
the first buffer stores therein data reproduced by the CD drive apparatus,
the compression unit reads the data stored in the first buffer therefrom and compresses the read data,
the second buffer stores therein the data compressed by the compression unit,
the recording unit reads the compressed data from the second buffer and records therein the read data,
the backup buffer management unit manages the backup buffer to be allocated to the second buffer,
the CD drive apparatus can adjust a data reproduction volume which is a volume of data to be reproduced per unit time, and
the decision unit generates a signal which adjusts the data reproduction volume based on a variation of the buffering quantity per unit time in the second buffer, and outputs the generated signal to the CD drive apparatus.

32. The recording and reproduction device as claimed in claim 15, further comprising a compression unit, the buffer including a first buffer and a second buffer, wherein
the first buffer stores therein data reproduced by the CD drive apparatus,
the compression unit reads the data stored in the first buffer therefrom and compresses the read data,
the second buffer stores therein the data compressed by the compression unit,
the recording unit reads the compressed data from the second buffer and records therein the read data,
the backup buffer management unit manages the backup buffer to be allocated to the second buffer,
the CD drive apparatus can adjust a data reproduction volume which is a volume of data to be reproduced per unit time, and
the decision unit generates a signal which adjusts the data reproduction volume based on a variation of the buffering quantity per unit time in the first buffer and a variation of a medium access throughput indicating a volume of the data supplied to the recording unit per unit time, and outputs the generated signal to the CD drive apparatus.

33. The recording and reproduction device as claimed in claim 15, further comprising a compression unit, the buffer including a first buffer and a second buffer, wherein
the first buffer stores therein data reproduced by the CD drive apparatus,
the compression unit reads the data stored in the first buffer therefrom and compresses the read data,
the second buffer stores therein the data compressed by the compression unit,
the recording unit reads the compressed data from the second buffer and records therein the read data,
the backup buffer management unit manages the backup buffer to be allocated to the second buffer,
the CD drive apparatus can adjust a data reproduction volume which is a volume of data to be reproduced per unit time, and
the decision unit generates a signal which adjusts the data reproduction volume based on a variation of a medium access throughput indicating a volume of the data supplied to the recording unit per unit time, a variation of the buffering quantity per unit time in the first buffer, and a variation of the buffering quantity per unit time in the second buffer, and outputs the generated signal to the CD drive apparatus.

34. The recording and reproduction device as claimed in claim 15, further comprising a compression unit, the buffer including a first buffer and a second buffer, wherein
the first buffer stores therein data reproduced by the CD drive apparatus,
the compression unit reads the data stored in the first buffer therefrom and compresses the read data,
the second buffer stores therein the data compressed by the compression unit,
the recording unit reads the compressed data from the second buffer and records therein the read data,
the backup buffer management unit manages the backup buffer to be allocated to the second buffer,
the CD drive apparatus can adjust a data reproduction volume which is a volume of data to be reproduced per unit time, and
the decision unit generates a signal which adjusts the data reproduction volume based on a variation of a medium access throughput indicating a volume of the data supplied to the recording unit per unit time and a variation of the buffering quantity per unit time in the second buffer, and outputs the generated signal to the CD drive apparatus.

35. The recording and reproduction device as claimed in claim 1, further comprising an analysis unit, wherein
the decision unit generates a signal which adjusts the data reproduction volume based on a comparison result obtained by comparing a variation of the buffering quantity or a variation of the volume of data flow to a predefined threshold value,
the analysis unit generates a signal which adjusts the threshold value of the dataflow volume variation based on an output tendency in the dataflow volume variation or a signal which adjusts the threshold value of the buffering quantity variation based on an output tendency in the buffering quantity variation, and outputs the generated signal, and
the decision unit adjusts the threshold values based on the adjustment signals.

36. The recording and reproduction device as claimed in claim 15, further comprising an analysis unit, wherein
the decision unit generates a signal which adjusts the data reproduction volume based on a comparison result obtained by comparing a variation of the buffering quantity or a variation of the volume of data flow to a predefined threshold value,
the analysis unit generates a signal which adjusts the threshold value of the dataflow volume variation based on an output tendency in the dataflow volume variation or a signal which adjusts the threshold value of the buffering quantity variation based on an output tendency in the buffering quantity variation, and outputs the generated signal, and
the decision unit adjusts the threshold values based on the adjustment signals.
